(19) United States
(12) Patent Application Publication
(10) Pub. No.: US 2018/0247296 A1
(43) Pub. Date: Aug. 30, 2018

(54) MOBILE PAYMENT SYSTEM

(71) Applicant: FOX GLACIER ASSET MANAGEMENT INC, Singapore (SG)

(72) Inventors: Tun Tun Win, Singapore (SG); Manickam Subramanian, Singapore (SG); Abhishek Modi, Singapore (SG); Shivam Srivastava, Singapore (SG)

(21) Appl. No.: 15/753,440

(22) PCT Filed: Oct. 27, 2016
(86) PCT No.: PCT/US2016/059154

§ 371 Date: Feb. 19, 2018

Related U.S. Application Data
(60) Provisional application No. 62/247,140, filed on Oct. 27, 2015.
(60) Provisional application No. 62/251,629, filed on Nov. 5, 2015.
(60) Provisional application No. 62/413,373, filed on Oct. 26, 2016.

(51) Int. Cl. G06Q 20/32; G06Q 20/40; G06Q 20/38; G06Q 30/02

(52) U.S. Cl. CPC G06Q 20/3255; G06Q 20/3227; G06Q 30/0207; G06Q 20/385; G06Q 20/3829; G06Q 20/40145

(57) ABSTRACT

The present document describes a payment system that processes transactions originating from mobile phones, cellular devices, Web browsers, or other mobile devices. A customer initiates a transaction by sending a payment request via SMS, HTTPS, or other network protocol. The payment request includes an amount to be paid and a phone number associated with a recipient. The payment system confirms the identity of the customer, and identifies the recipient based at least in part on the phone number. The payment system supports the fulfillment of payment requests with various combinations of account balances, credit accounts, discounts, and loyalty points. The payment system also provides various merchant features such as ticket vending, automatic discovery of payees and payers, management of merchant terminals, and payroll processing.

### RELATED APPLICATION AND PRIORITY CLAIM

This application is a U.S. National Stage Application of PCT/US2016/059154 filed Oct. 27, 2016, entitled “MOBILE PAYMENT SYSTEM”, which claims the benefit of priority to U.S. Provisional Application No. 62/247,140, filed on Oct. 27, 2015, entitled “SPEED KYAT MOBILE PAYMENTS”, 62/251,629, filed on Nov. 5, 2015, entitled “MOBILE PAYMENT SYSTEM”, and 62/413,373, filed on Oct. 26, 2016, entitled “MOBILE PAYMENT SYSTEM”, the contents of each of which is incorporated by reference herein in its entirety.

### BACKGROUND

Online commerce has evolved to become an important part of the economy. With the growth of the Internet, consumers are now able to buy products online and have them delivered without visiting a physical business establishment. As computing devices have become smaller and more mobile, the ability to access online shopping services has been added to mobile devices such as cellular phones. When purchasing online goods and services, payment processing systems have evolved to allow goods and services purchased online to be paid for with credit cards or electronic fund transfers. Such payments are convenient for customers, because they do not require the exchange of physical money, making change, and allow for easy access to credit.

### BRIEF DESCRIPTION OF THE DRAWINGS

Various techniques will be described with reference to the drawings, in which.

FIG. 1 shows an illustrative example of an environment in which various embodiments may be practiced.

FIG. 2 shows an illustrative example of an environment where a number of clients interact with a payment service using various communication protocols.

FIG. 3 shows an illustrative example of a transaction between a sending device and a receiving device.

FIG. 4 shows an illustrative example of a block diagram for a payment service.

FIG. 5 shows an illustrative example of a payment service architecture that processes transactions submitted by mobile devices.

FIG. 6 shows an illustrative example of a process that, when performed by a client application on a customer's cellular device, registers the customer's cellular device with a payment service.

FIG. 7 shows an illustrative example of an environment in which a customer device is registered for use with a payment service by, at least confirming that a SIM card in the customer device matches a phone number supplied by the customer.

FIG. 8 shows an illustrative example of a process that, when performed by a client application on a customer cell phone, determines whether a phone number provided by the customer matches a phone number associated with the cell phone.

FIG. 9 shows an illustrative example of an environment in which a customer device is registered for use with a payment service by, at least confirming that a SIM card in the customer device matches a phone number supplied by the customer via an HTTP connection.

FIG. 10 shows an illustrative example of a process that, when performed by a client application on a customer cell phone, and a payment service, confirms that a phone number provided by a customer matches a phone number associated with the customer cell phone.

FIG. 11 shows an illustrative example of a process that, when performed by a payment service, processes a login request from a customer cell phone.

FIG. 12 shows an illustrative example of a process that, when performed by a payment service, confirms the identity of the customer and authorizes a replacement device.

FIG. 13 shows an illustrative example of a process that, when performed by a customer cell phone and a payment service, submits and validates a payment request via SMS.

FIG. 14 shows an illustrative example of a process that, when performed by a customer cell phone, a payment service, and a recipient cell phone, processes a payment request sent from the customer cell phone to the a recipient that is identified with a phone number.

FIG. 15 shows an illustrative example of a data structure for maintaining user, device, and account information associated with a payment system.

FIG. 16 shows an illustrative example of a process that, when performed by a payment service, processes a payment request using a combination of payment sources.

FIG. 17 shows an illustrative example of an environment that broadcasts payment information from a merchant device to prospective customer devices.

FIG. 18 shows an illustrative example of a process that, when performed by a merchant cell phone and a customer cell phone, activates a merchant terminal when the merchant cell phone enters a commerce location, and broadcasts default payment information to the customer cell phone via a wireless hotspot.

FIG. 19 shows an illustrative example of a device and menu usable by a head cashier and a device and menu usable by a subordinate cashier.

FIG. 20 shows an illustrative example of an environment that processes payments from a customer to a subordinate cashier under the authority of a head cashier.

FIG. 21 shows an illustrative example of a process that, when performed by a payment service, a customer, and a subordinate cashier, processes a payment from the customer to the head cashier via the subordinate cashier.

FIG. 22 shows an illustrative example of a customer device that provides electronic ticketing functions.

FIG. 23 shows an illustrative example of a process that, when performed by a payment service, performs a lucky draw promotion for a product scanned by a customer device.

FIG. 24 shows an illustrative example of a process that, when performed by a payment service, presents product promotions on a customer device based at least in part on a geo location of the customer device.

FIG. 25 shows an illustrative example of a process that, when performed by a payment service, identifies merchants that miss promotional opportunities and presents promotional alternatives to the merchants.

FIG. 26 illustrates an environment in which various embodiments can be implemented. And,

FIG. 27 illustrates aspects of an example environment for implementing aspects in accordance with various embodiments.

### DETAILED DESCRIPTION

The current document describes a system that facilitates the processing of financial transactions using mobile devices. The system supports mobile devices such as cell phones, laptops, smart phones, tablet computers, wearable devices, and other wireless appliances. Both customers and merchants are able to use their respective mobile devices to initiate and manage financial transactions. The mobile devices communicate with a payment service that runs on a server computer system, server cluster, or online computing service. In various examples, a merchant registers a merchant mobile device with the payment service by linking a phone number associated with the merchant mobile device to a merchant account managed by the payment service. A customer registers a customer mobile device with a payment service by linking a phone number associated with the customer mobile device to a customer account managed by the payment service, or other payment source. The customer makes a payment to the merchant by at least in part entering, via an application running on the customer mobile device, the phone number associated with the merchant device, and a payment amount. The customer mobile device submits the payment request to the payment service. The payment service transfers the requested funds from the customer's account to the merchant's account, and sends notifications to the customer mobile device and the merchant mobile device. The payment system supports a variety of business management features such as promotion management, payroll management, and cashier functions. In various examples, the payment service provides high availability and scalability by implementing a multi-tiered and distributed architecture. A plurality of modules of the payment service may be deployed on a single server or a single module of the payment system may be distributed over a plurality of servers.

The payment service includes a transaction manager, a messaging gateway, a transaction database, and a moderator. The transaction manager manages the flow of transactions through the payment system by at least in part decrypting transaction messages received from the mobile devices, storing the received transaction messages in a safe store, and retrying and recovering from failed transactions. The messaging gateway interfaces to a Short Message Service Center (“SMSC”) communication link that is able to communicate with the mobile devices. The messaging gateway performs load sharing operations to balance message traffic over multiple links, and routes messages to particular SMSC's. The messaging gateway also supports short message peer-to-peer (“SMPP”), hypertext transfer protocol (“HTTP”), hypertext transfer protocol secure (“HTTPS”), and simple object access protocol (“SOAP”) protocols. The messaging gateway may be extended to support communication protocols used by various service providers, financial institutions, or online merchants. The transaction database retains transactions that are submitted to the payment service. The transaction database may be used to provide reports on past transactions. The moderator provides, to modules of the payment service, a common interface to external services which are used to fulfill customer transactions in real time. The moderator may support a number of external APIs supported by the external services such as ISO 8583 for interfacing with financial institutions, SOAP for interfacing with stock markets, and web interfaces for interfacing with telecommunication service providers.

The mobile devices include an application designed to interact with the payment service. The application includes a number of optional application modules that support merchant and/or customer functionality. In some examples, the application includes an electronic ticketing module. The electronic ticketing module issues tickets in exchange for payment, manages the collection and validation of issued tickets, and assists service providers with providing services in accordance with the issued tickets. In another example, the application includes investment management features including the purchase and sale of stock, and the voting of share proxies. In yet another example, the application includes payroll management functions, and retail cashier management functions. In yet another example, the application allows merchants to manage product promotions and marketing incentives such as loyalty points, cash back rewards, and product discounts.

In one example, a merchant downloads a merchant application to a smart phone owned by the merchant. The merchant runs the merchant application, and registers with the payment service by in part entering a phone number associated with the smart phone. The payment service generates an account for the merchant and associates the account with the phone number supplied by the merchant. The merchant configures the smart phone to broadcast a merchant identifier using a Wi-Fi or Bluetooth hotspot. To interact with the merchant, the customer downloads a customer application to a customer device such as a cell phone. The customer registers with the payment service by at least in part providing the phone number associated with the customer device, and by specifying a method of payment. As the customer moves within range of the merchant's hotspot, the customer application running on the customer device detects the broadcasted merchant identifier, and contacts the payment service. If the merchant has created product promotions through the payment service, the payment service notifies the customer of the active promotions via the customer device to attract the customer to the merchant. If the customer makes a purchase from the merchant, payment information including the merchant's phone number can be pre-populated based at least in part on the merchant ID broadcast via the merchant's hotspot.

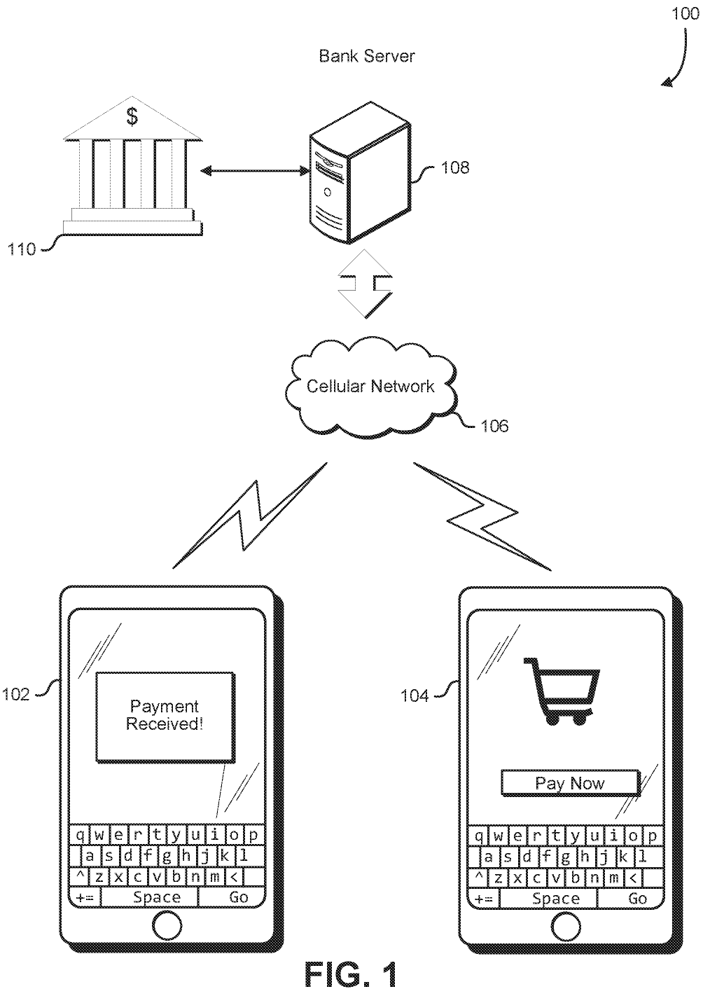

FIG. 1 shows an illustrative example of an environment in which various embodiments may be practiced. A system 100 includes a merchant device 102 and a customer device 104 that communicate over a cellular network 106 with a payment service hosted by a server computer system 108. The server computer system 108 communicates via an application programming interface (“API”) with a transaction service provider 110 such as a bank, stock exchange, or telecommunications operator. The merchant device 102 and the customer device 104 can be a cell phone, a smart phone, a tablet computer, or other personal computer system with a cellular interface.

Mobile applications on the merchant device 102 and the customer device 104 facilitate financial transactions between a merchant and a customer. The merchant device 102 runs a merchant application. The merchant application facilitates the registration of the merchant device 102 with the payment service by submitting, to the payment service, information that identifies the merchant and a phone number associated with the merchant device 102. The payment service links a merchant account to a phone number associated with the merchant device 102. In some examples, the merchant account is maintained by the payment service. In another example, the merchant account is maintained by the transaction service provider 110. In yet another example, the payment service determines a balance or deficit for the merchant on a periodic basis, and reconciles the balance or deficit with a corresponding account maintained by the transaction service provider 110. The periodic basis may be a daily period, a weekly period, or a monthly period. In various examples, merchants are able to make payments to customers, and recover cash balances from the payment service. In some implementations, merchants may be limited to making payments to a single phone number or set of phone numbers. The merchant application may facilitate the setting of promotional parameters such as reward points and rebates.

The customer device 104 runs a customer application. The customer application facilitates registration of the customer device 104 with a payment service by collecting information associated with the customer and a phone number associated with the customer device 104. In some examples, the application collects the signature of the customer, and a photograph of the customer. Using the customer application, a customer is able to make a payment to the merchant by submitting, to the payment service, a payment request that includes the phone number of the merchant device 102 and a payment amount. The payment service receives the payment request, and fulfills the payment request by transferring funds from the customer's account to the merchant's account. The payment service sends a notification to the merchant device 102 indicating that a payment has been received.

The application on the customer device 104 may provide a failure-resistant transaction processing system. When a transaction is sent from the customer device 104 to the payment service, the failure-resistant transaction processing system retains the pending transaction in a safe store on the sending device. The pending transaction can include retry parameters such as a maximum number of retries, a retry time between retransmissions, and a timeout value. If a confirmation is not received for the pending transaction within an associated retry time, the pending transaction may be retransmitted to the payment service. Pending transactions are retained in the safe store on the customer device 104 until a confirmation message from the payment service indicates that the pending transaction has been successfully received and processed. An identifier on the pending transaction is used to avoid processing the pending transaction more than once. Pending transactions that fail may be recorded in a failed message log on the customer device 104.

In some examples, an account maintained by the payment service may be associated with a plurality of customers. A policy maintained by the payment service may be used to define a number of conditions under which an account action, such as a payment, may be authorized. In some implementations, all customers in the plurality of customers must authorize the account action. In another implementation, a threshold number of the plurality of customers must authorize the account action. In yet another implementation, a first threshold number of customers are required to authorize an account action, and a second threshold number of customers are required to revoke an authorization.

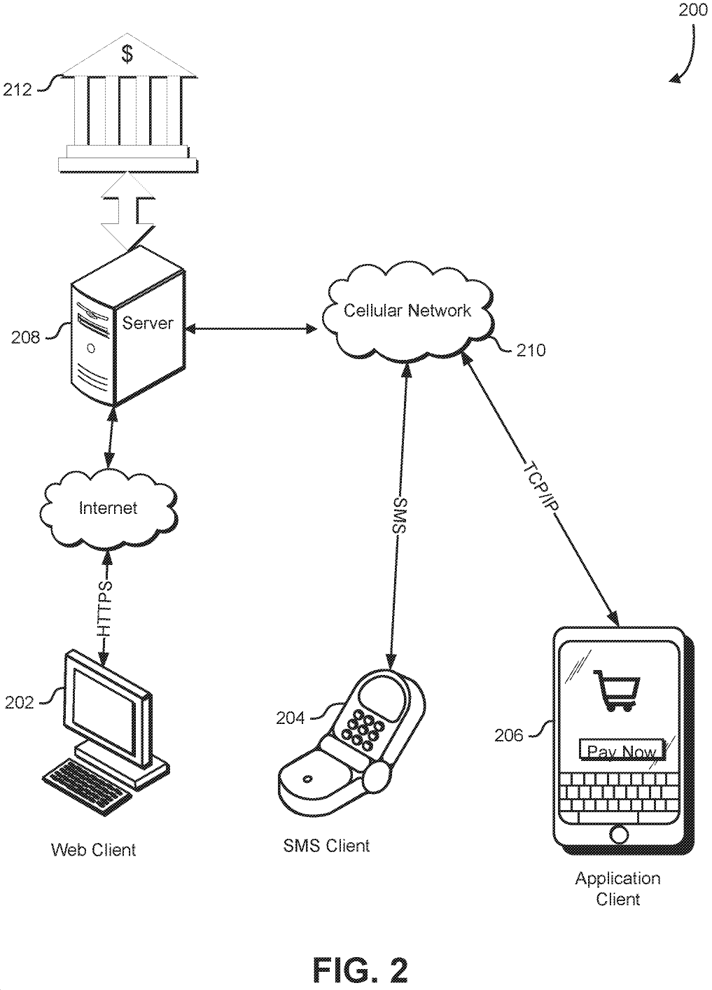

FIG. 2 shows an illustrative example of an environment where a number of clients interact with a payment service using various communication protocols. An environment 200 includes a web client 202, an SMS client 204, and an application client 206. The web client 202 can be a personal computer running a web browser, a tablet computer, or mobile phone that includes a web browser. The web client 202 uses an HTTP secure protocol to communicate over the Internet with a payment service hosted by a server 208. The web client 202 may be connected to the Internet with a wired, wireless, or Bluetooth connection. The SMS client 204 is a mobile phone or handheld device capable of sending SMS messages. In some examples, the SMS client 204 is a wireless device that sends SMS messages through an SMS Gateway. The SMS client 204 uses a Short Message Service (“SMS”) protocol to communicate with the payment service via a cellular network 210. The application client 206 is a smart phone or other handheld device capable of running user-specified applications. In various examples, the application client 206 is an iPhone or android device. The application client 206 uses a TCP/IP protocol to communicate with the payment service via the cellular network 210. In some examples, the application client 206 communicates with the payment service using a secure HTTP (“HTTPS”) connection. The payment service interacts with an API provided by a financial institution 212 such as a bank, stock exchange, or private corporation.

In various implementations, the payment service includes security features that limit access to customer information. In one example, the payment service generates a captcha which is presented to the customer. The customer is able to enter an answer to the captcha from the web client 202, and the web client 202 returns the answer to the payment service. If the payment service confirms that the returned answer is correct, the payment service determines that the web client 202 is controlled by a human being. If the payment service determines that the returned answer is not correct, the payment service determines that the web client 202 is not controlled by human being, and blocks access to the payment service. In another example, the payment service sends a multi-digit one-time-use pass code (“OTP”) to the SMS client 204 via SMS. The destination for the OTP is based at least in part on a phone number associated with a Subscriber Identity Module (“SIM”) installed in the SMS client 204. The OTP expires on first use or after a configurable expiration time has expired. In yet another example, the payment service requires an alphanumeric password to be submitted by the application client 206. The alphanumeric password is verified upon receipt by the payment service.

In some examples, an OTP is sent to an application which is registered to a particular phone number. A customer is able to view the OTP after successfully logging in to the application using the device associated with the particular phone number. If another customer attempts to view the OTP from another device not associated with the particular phone number, the application determines that the SIM of the other device is not associated with the particular phone number, and prevents the other customer from viewing the OTP.

Additional transactions may be submitted to the payment service via HTTP secure from the web client 202, via SMS from the SMS client 204, and via TCP/IP from the application client 206. For example, using a web browser on the web client 202, a customer may enter a merchant's phone number and an amount to be paid. By submitting the form, the web client 202 transmits the information to the payment service running on the server 208. In another example, the SMS client 204 may submit the merchant's phone number and amount to be paid to the payment service via an SMS message. In yet another example, the customer may enter the merchant's phone number and the amount to be paid into a dialog box presented by the application client 206. The application client 206 collects the information from the dialog box, and transmits the information to the payment service. For devices that do not have a cellular interface, a virtual phone number may be assigned to the device by the payment service to facilitate interaction with the service.

Because sensitive transactions may be performed using the payment service, in many contexts the platform operates in accordance with heightened security guidelines. Within the payment service, passwords and marketing personal identification numbers (“MPINs”) are encrypted in a database using a secure encryption algorithm, such as the MD5 algorithm. MPINs are not shown in clear-text on the user interface, and are obscured in system logs.

In various examples, communications between customer devices and the payment service are encrypted with Triple DES encryption (“3DES”). Requests coming into the payment service via SMS are encrypted using 3DES, to provide increased data security during transmission from mobile devices to the payment service. 3DES is a block cipher formed from the Data Encryption Standard (DES) cipher by iterating standard DES three times. 3DES enlarges the key space of standard DES without relying on a different encryption algorithm 3DES provides added protection against meet-in-the-middle attacks that may be effective against double or single DES encryption.

Message-Digest algorithm 5 (“MD5”) hashing is a cryptographic hash function with a 128-bit hash value, and is described in Internet standard RFC 1321 which is herein incorporated by reference. An MD5 hash may be expressed as a 32 digit hexadecimal number. An MD5 hash is generated using a one-way algorithm that is easy to determine but difficult to reverse.

The above-described cryptographic techniques may be applied to other communication mechanisms used by the payment service such as self-care, SMS, and WEB interfaces. If a web service client is used to access the payment service, the Web service client is authenticated using a username and password. Non-authenticated web service clients are not allowed to access the payment service.

In some implementations, executable instructions associated with a client application are stored on computer readable media in an encrypted form. During operation of the client application, the executable instructions are retrieved from the computer readable media, decrypted, and executed by a processor on the client device.

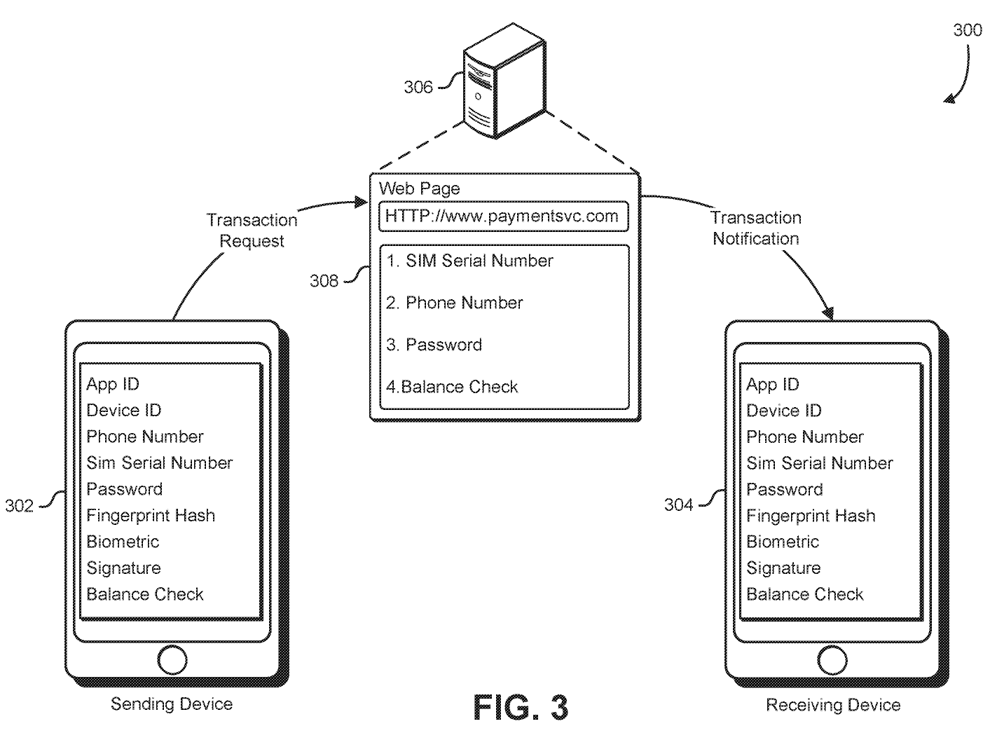

FIG. 3 shows an illustrative example of a transaction between a sending device and a receiving device. An environment 300 includes a sending device 302 and a receiving device 304. The server 306 hosts a payment service. The payment service exports a variety of interfaces including a web interface, an SMS interface, and a network API. The web interface includes a webpage 308 that allows customer devices to interact with a payment service via a web browser. A customer initiates a transaction to the owner of the receiving device 304 using an application installed on the sending device 302.

As a result of initiating the transaction, the sending device 302 validates and sends, to the receiving device 304, an application ID, a device ID, a phone number, a SIM serial number, a password, a fingerprint hash value, a biometric value, a signature, and an account balance. The application ID is an identifier assigned by the payment service that identifies the particular instance of the application running on the sending device 302. The device ID is an identifier associated with the sending device 302. The phone number is the phone number assigned to the sending device 302. The SIM serial number is the SIM number of the SIM installed in the sending device 302. The password is the password chosen by the user of the sending device 302. The fingerprint hash value is a hash value generated based at least in part on a fingerprint image supplied by the user of the sending device 302. The biometric value is a hash of a biometric measure acquired by the sending device 302. In various examples, the biometric value is a hash of a retina scan, a voiceprint, or an image or video clip of the person's face. The signature is an image of a signature captured by signing the screen of the sending device 302. In some implementations hash value of the signature is used. The account balance is a combination of the available payment sources accessible to the user of the sending device 302. In some examples, the account balance includes bank account balances, loyalty points, discount awards, and lines of credit.

The sending device 302 can submit a variety of transaction types to the payment service. In various examples, the sending device 302 can send a registration request, a payment request, a bill, an account management request, or a utility request. A registration request registers a new device or user with a payment service. A payment request transfers money from an account associated with the sending device to another user of the payment system. In various examples, the payment request may represent a utility payment, a payment for a bus or airline ticket, an e-commerce payment, or a top-up payment. A bill requests payment from another user of the payment system. An account management request transfers funds from one account to another account, where both accounts are associated with the sending device 302. A utility request modifies settings and information associated with the payment service such as updating the customer's password, phone number, or payment accounts.

The payment service receives a transaction from the sending device 302, processes the received transaction, and sends a corresponding notification to the receiving device 304. The payment service sends various notifications to the receiving device 304 including payment receipt notifications, account reconciliation notifications, and bill receipt notifications. In some implementations, the notifications may be sent via a network messaging system such as Google Cloud Messaging (“GCM”) or via an application notification system such as Apple Push Notification (“APN”).

The webpage 308 shows an example of a web interface provided by the payment service. The webpage 308 shows utility operations that allow a user of the payment service to view the phone number and SIM serial number of their device change the password used to access the payment service, and check account balances. In some implementations, if a SIM card associated with the device is replaced, and a user attempts to login to the payment service, the payment service will deny the login attempt and re-verify the user. To re-verify the user, the payment service will ask the user to enter the date of birth, passport, and onetime-use password. If the information requested by the payment service is confirmed, the payment service updates the SIM information associated with the user to correspond to the new SIM card. After the SIM information is updated, the user is able login to the payment service.

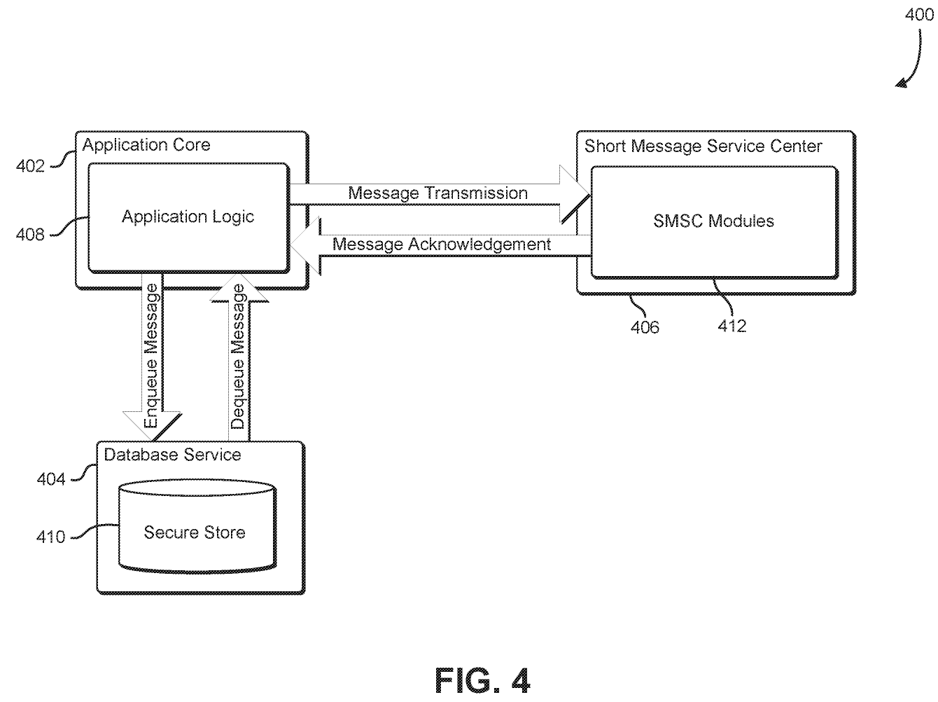

FIG. 4 shows an illustrative example of a block diagram for a payment service. A block diagram 400 includes an application core 402, a database service 404, and a Short Message Service Center 406. The application core 402 includes application logic 408 that processes transaction requests and sends notifications associated with processed transactions. The database service 404 includes a secure store 410 and retains transactions that are received by the payment system until processing is completed and confirmed. The Short Message Service Center 406 includes a number of SMSC modules 412 that are used to communicate with mobile devices operated by customers and merchants.

In various examples, the Short Message Service Center 406 receives a transaction request, such as a payment request, from a customer device. The transaction request includes a transaction ID, and identifies a requester. Payment requests include information that identifies a recipient and an amount of funds to be transferred. The short message service Center 406 forwards the message to the application core 402. The application core 402 stores the message and the secure store 410. The application logic 408 reads messages from the secure store 410, and attempts to fulfill the requests. For a payment request, the application logic 408 identifies the requester, an account associated with the requester, the specified recipient, and an account associated with a recipient. The application logic 408 transfers an amount of funds specified in the payment request from the requester's account to the recipient's account. If the transfer is successful, the application logic 408 sends a notification to the recipient using the short message service Center 406. The application logic 408 updates the transaction record in the secure store 410 to indicate that the transaction is complete and may, in various examples, retain a copy of the transaction so the duplicate transactions may be detected. If an additional transaction is received having a transaction ID that matches a transaction ID from the past transaction retained and the secure store 410, the additional transaction is discarded.

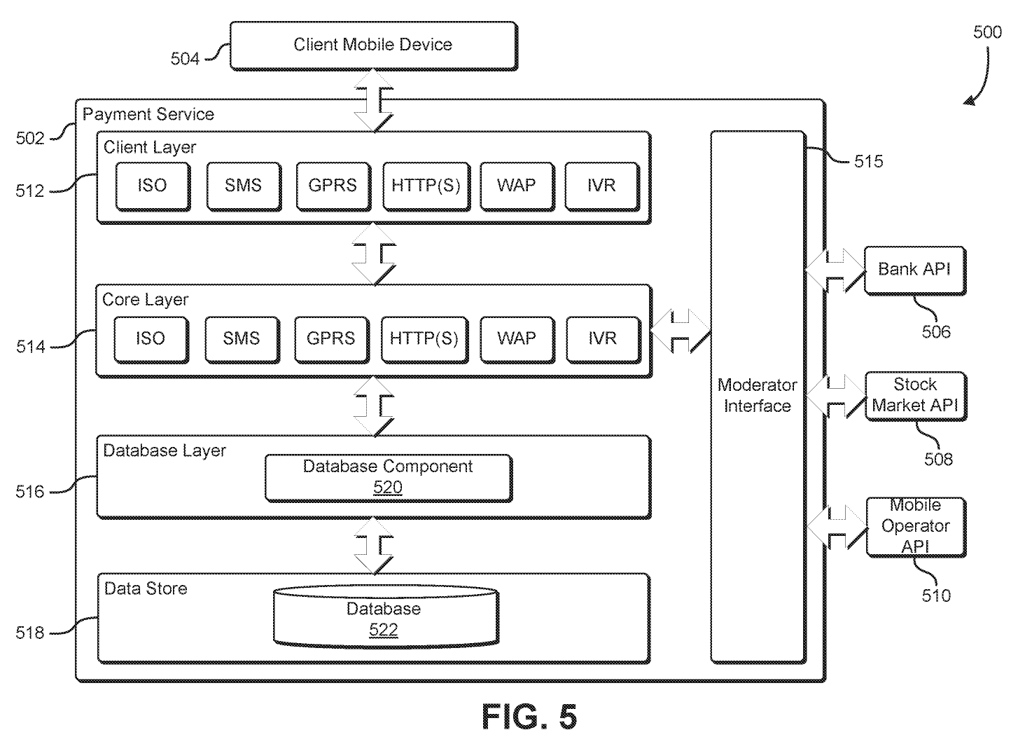

FIG. 5 shows an illustrative example of a payment service architecture that processes transactions submitted by mobile devices. A block diagram 500 illustrates a payment service 502 that processes transactions received from a client mobile device 504. The payment service 502 interfaces with a bank API 506 associated with the bank, stock market API 508 associated with a stock market, and a mobile operator API 510 associated with a cellular phone service provider. The bank API 506 may be a web interface, a Simple Object Access Protocol (“SOAP”) interface, or an ISO 8583 compliant interface. The stock market API 508 can be a SOAP interface or other web API that interfaces with a stock exchange server or other brokerage service to provide securities trading information and perform securities transactions. The mobile operator API 510 can be a web interface, SMS interface, or Interactive Voice Response system (“IVR”) that allows the payment service 502 to transfer funds to the cellular service provider of the client mobile device 504. The client mobile device 504 can be a cell phone, a smart phone, a handheld mobile device, or a web browser. The client mobile device 504 may communicate with the payment service 502 in a variety of ways by accessing a client layer 512 of the payment service 502.

The payment service 502 includes a client layer 512. The client layer 512 provides a communication interface between the payment service and the client mobile device 504. A variety of communication protocols are supported by the client layer 512 including SMS, HTTP, HTTP secure, General Packet Radio Service (“GPRS”), Wireless Application Protocol (“WAP”), Interactive Voice Response (“IVR”) system, and ISO 8583. The payment service 502 includes a core layer 514. The core layer 514 manages the flow of transactions through the payment service 502 including decryption, authentication, and authorization of received transaction requests. The core layer 514 supports communications between the payment service 502 and a number of external service providers such as banks, stock exchanges, and private corporations. The core layer 514 includes a variety of protocols for communicating with outside services including SMS, HTTP, HTTP secure, General Packet Radio Service (“GPRS”), Wireless Application Protocol (“WAP”), Interactive Voice Response (“IVR”) system, and ISO 8583.

A Moderator 515 acts as a mediation layer between the core layer 514 and the external financial services used to fulfill transaction requests. The moderator 515 provides, to the core layer 514, a common interface to external services which are used to fulfill received transaction requests. The moderator 515 connects and interacts with the external system via adapters. The adapters are configured in the moderator 515. The adapters transform requests for external transactions from an internal XML API format into a format required by the external financial services and vice versa. For example, prepaid cellular devices can make payments to their associated mobile service accounts using a wide range of protocols such as CORB A, RMI, Web Service/SOAP, JDBC, and XML over HTTP. Existing merchant bill-paying systems can be adapted for online bill paying functionality using a similar set of protocols such as Web Service/SOAP, or XML over HTTP.

The core layer 514 stores received transaction requests in a data store 518 using a database layer 516. The database layer 516 includes a relational database component 520 such as a SQL Server installation or an Oracle installation. The relational database component 520 provides functionality including database change management, data indexing, and data query functions. The data store 518 provides physical storage capabilities for the database layer 516 by providing access to a storage device 522 such as a disk drive or flash memory device. As the core layer 514 processes the stored transaction requests, the core layer 514 updates a status field in the data store 518 to indicate that the particular transaction request has been fulfilled.

In one implementation, a payment request is transmitted via SMS from the client mobile device 504 to the payment service 502. The payment request is received by an SMS support module in the client layer 512. The SMS support module translates the payment request into a standard payment request format that includes the phone number associated with the requester, a phone number associated with the recipient, a transaction ID, and a payment amount. The formatted payment request is forwarded to the core layer 514.

The core layer 514 stores the payment request in a transaction queue maintained within the data store 518. The transaction ID, a retry time, an initial number of retries, and a transaction status are stored with the payment request. The retry time and the initial number of retries may be configured by an administrator of the payment service 502. The core layer 514 queries pending requests from the transaction queue, and attempts to fulfill them. If a particular request cannot be fulfilled by the core layer 514, the particular transaction is returned to the transaction queue for the retry time, and the number of retries for the particular transaction is decremented. If the number of retries for a transaction reaches zero, the requester associated with the transaction is notified that the transaction has failed, and the transaction is removed from the transaction queue. When a transaction is fulfilled by the core layer 514, the transaction status of the transaction is updated to ‘fulfilled’, the parties to the transaction are notified, and the transaction record is retained in the transaction queue.

When the core layer 514 queries the payment request from the transaction queue, the core layer 514 authenticates the payment request by authenticating the identity of the requester, and identifying a destination account associated with the recipient. If the phone number associated with the recipient is not registered (an unregistered phone number) with the payment service 502, a temporary registration is generated that includes a holding account. Funds may be received into the holding account, and a notification sent to the phone number associated with the holding account that funds are available. The core layer 514 authorizes the payment request by at least in part determining that the payment sources associated with the requester are sufficient to fulfill the request.

The core layer 514 fulfills the payment request by interacting, via the moderator 515, with a number of external financial services. In one example, the core layer 514 sends commands to a bank via a bank API 506 to transfer funds from the requester's account to the recipient's account. In another example, the payment service 502 acts as an intermediary by maintaining local account balances for registered users of the payment service 502. Local account information may be maintained in the data store 518. If a local account balance falls below low threshold value, the core layer 514 transfers funds from an external account associated with the local account to an account associated with the payment service 502, and the local account balance is credited a corresponding amount. If the local account balance exceeds a high threshold value, the core layer 514 deducts funds from the local account balance and transfers funds from an external bank account associated with the payment service 502 to an external account associated with the local account. The low threshold value and the high threshold value may be determined based on payment patterns and transaction costs associated with transferring account balances in and out of the payment service 502. For example, the low threshold value may be determined based on an amount of funds that would be necessary to satisfy the majority of past payments, and the high threshold value may be determined as the total amount of outgoing payments over the previous one-month period.

Once the payment request is fulfilled, the core layer 514 notifies the requester and the recipient that funds have been transferred. In some examples, the core layer 514 performs additional operations related to the payment request such as crediting merchant loyalty points, awarding cash back for purchases, or awarding discounts for future purchases.

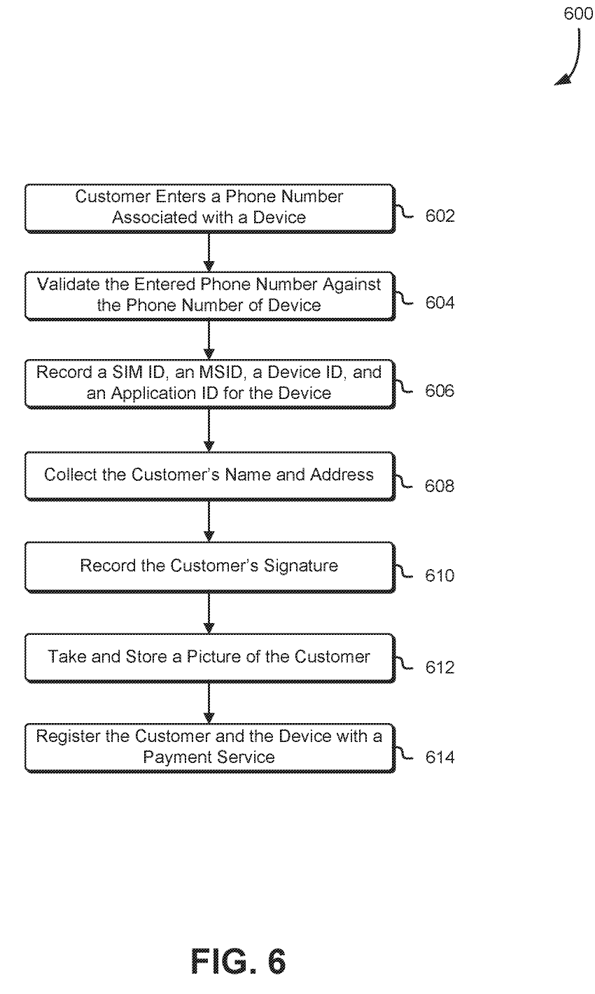

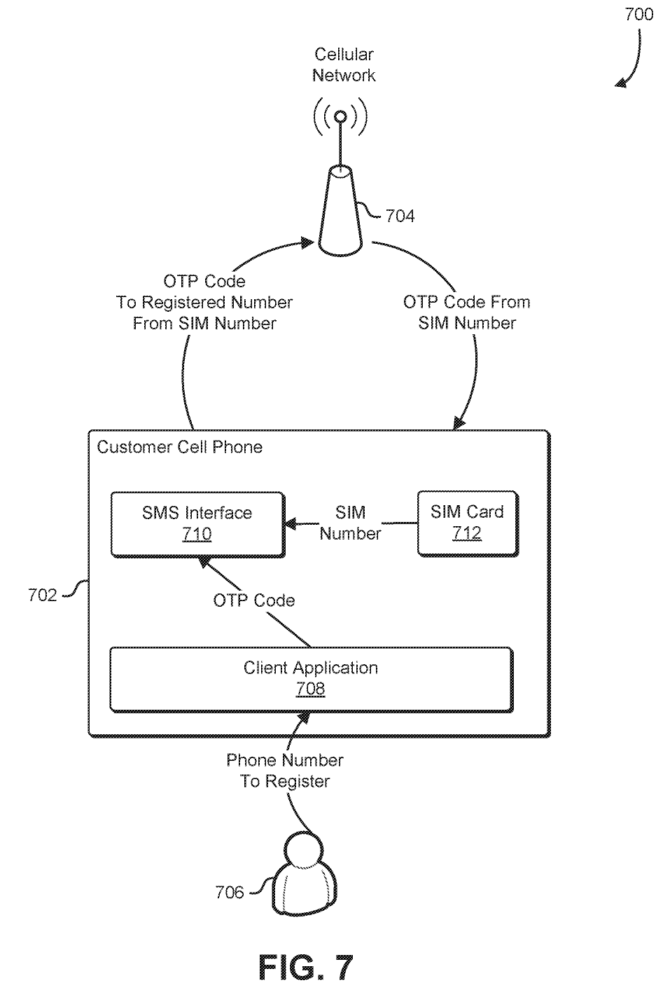

FIG. 6 shows an illustrative example of a process that, when performed by a client application on a customer's cellular device, registers the customer's cellular device with a payment service. A process diagram 600 illustrates a registration process that begins at block 602 where a client application running on a cellular device prompts the customer to enter a cell phone number to register with the payment service. The client application validates the entered cell phone number against the phone number of the cellular device. Techniques for validating the entered cell phone number against the phone number of the cellular device are shown in FIGS. 7-8 and FIGS. 9-10. If the entered cell phone number does not match the phone number of the cellular device, the registration process terminates and the cellular device is not registered with the payment service.

If the entered cell phone number is successfully validated, execution proceeds to block 606 where the client application acquires a SIM ID, a mobile station ID (“MSID”), a Device ID, and an application ID. The SFM ID may be read from configuration memory in a removable SIM card installed in the cellular device. The MSID and the Device ID may be acquired by reading the information from configuration memory within the cellular device. The application ID is generated as a result of installing the client application on the customer's cellular device and identifies the particular instance of the client application being registered.

At block 608, the client application collects registration information from the customer such as the customer's name and the customer's mailing address. The client application then prompts the customer to enter a signature on the screen of the device. When the customer enters the signature, the client application records 610 the pattern of motion as well as the resulting image as the customer's signature. As an additional means of verification, the client application captures 612 a digital photograph of the customer. In some examples, the client application captures a video clip of the customer to ensure that the customer is a living person. At block 614, the client application transmits the collected information to the payment service in the form of a registration request. In response, the payment service validates the registration request and registers the customer and the customer's cellular device with the payment service.

FIG. 7 shows an illustrative example of an environment in which a customer device is registered for use with a payment service by, at least in part, confirming that a SIM card in the customer device matches a phone number supplied by the customer. An environment 700 includes a customer cell phone 702 that communicates with a cellular network 704 operated by a cellular service provider. A customer 706 registers the customer cell phone 702 with a payment service using a client application 708 running on the customer cell phone 702. As part of the registration process, the client application 708 receives, from the customer 706, a phone number to register with the payment service. The client application 708 displays, on a display screen connected to the customer cell phone 702, a prompt to enter the phone number to register. In response, the customer 706 enters the phone number using a keypad or touch screen interface on the customer cell phone 702.

The client application 708 verifies that the phone number provided by the customer 706 is the phone number assigned to the customer cell phone 702. To verify that the phone number provided by the customer 706 matches the phone number assigned to the customer cell phone 702, the client application 708 sends, via SMS, an OTP Code to the phone number provided by the customer 706 using an SMS interface 710. The phone number assigned to the customer cell phone 702 is based at least in part on the contents of a SIM card 712. The SIM card 712 provides information to the SMS interface 710 that determines the originating number of the SMS message. If the phone number provided by the customer 706 matches the phone number assigned by the cellular service provider, the SMS message sent by the client application 708 containing the OTP code will be received by the customer cell phone 702. In some implementations, the client application 708 identifies the sender of the received SMS message and confirms that the center of the received SMS message matches the phone number provided by the customer 706. If the customer cell phone 702 does not receive an SMS message containing the OTP code, the client application 708 determines that the phone number provided by the customer 706 is different than the phone number assigned by the cellular service provider, and the registration request is denied.

In some examples, the customer 706 is prompted by the customer cell phone 702 to enter his/her phone number for registration. Once the customer enters the phone number, the client application sends a random 16-digit code to the phone number entered by the customer. If a SIM that matches the entered phone number is present in the customer cell phone 702, then the customer cell phone 702 will receive the 16-digit code. The client application 708 listens to incoming messages and when it receives the 16-digit code, it checks the identity of the sender of the 16-digit code SMS. If the sender's phone number matches the phone number entered by the Customer, it is verified that the matching SIM is present in the phone.

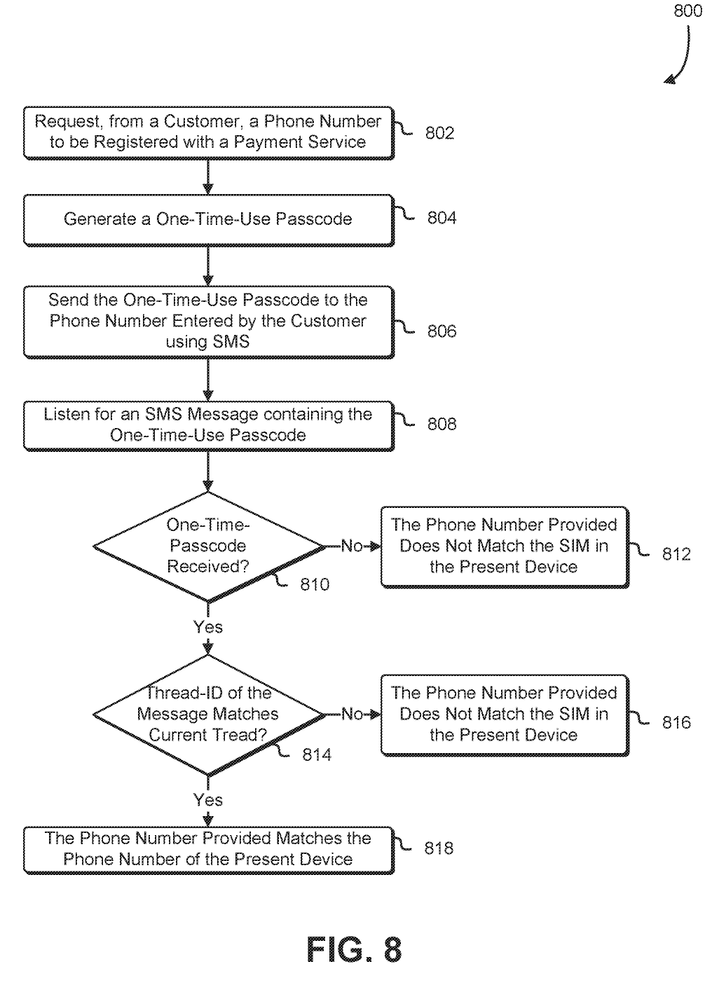

FIG. 8 shows an illustrative example of a process that, when performed on a customer cell phone, determines whether a phone number provided by the customer matches a phone number associated with the cell phone. A process diagram 800 shows a process that begins at block 802 with a client application running on the cell phone requesting, from the customer, a phone number to be registered with a payment service. The phone number may be entered using a keypad, a touch screen, or a voice interface on the customer cell phone. The client application generates 804 a one-time-use pass code. In some examples the one-time-use pass code is a 16 digit alphanumeric code. In some implementations, the client application determines a thread ID associated with the client application and adds the thread ID to the message containing the one-time-use pass code. In another implementation, the client application determines a hash value or cryptographic signature corresponding to the thread ID, and adds the hash value or cryptographic signature to the message containing the onetime-use pass code. The client application sends 806 an SMS message from the cell phone including the one-time-use pass code to the phone number provided by the customer at block 802.

At block 808, the client application listens for an SMS message containing the onetime-use pass code. If no SMS messages received after the threshold amount of time, the client application determines that the phone number provided by the customer does not match the phone number associated with the cell phone. The threshold amount of time may be determined by measuring the round-trip time of an SMS message, and multiplying the measured time by a safety factor of two. If an SMS message is received, execution proceeds to decision block 810 and the client application determines if the received SMS message includes the one-time-use pass code. If the SMS message does not include the one-time-use pass code, the client application determines 812 that the phone number provided by the customer does not match the phone number associated with the cell phone. If the SMS message does include the one-time-use pass code, execution advances to decision block 814, and the client application determines whether the thread ID in the message matches the thread ID of the client application. If the thread ID of the message does not match the thread ID of the client application, execution advances to block 816 where the client application determines that the phone number provided by the customer does not match the phone number associated with the cell phone. If the thread ID of the message matches the thread ID of the client application, execution proceeds to block 818, and the client application determines that the phone number provided by the customer matches the phone number associated with the cell phone. In some implementations, as an additional verification, the client application confirms that the sender of the received SMS message matches the phone number provided by the customer at block 802.

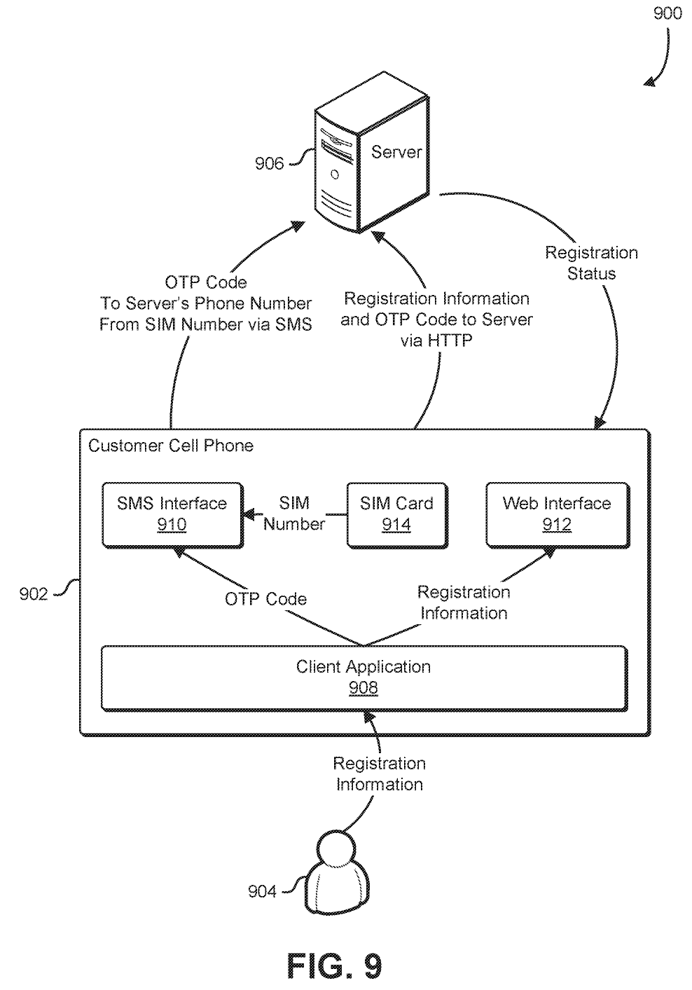

FIG. 9 shows an illustrative example of an environment in which a customer device is registered for use with a payment service by at least confirming that a SIM card in the customer device matches a phone number supplied by the customer via an HTTP connection. An environment 900 includes a customer cell phone 902 operated by a customer 904. The customer cell phone 902 communicates with a server 906 that hosts a payment service. The payment service is accessible to the customer cell phone 902 via both SMS and TCP/IP protocols.

In various examples, the customer cell phone 902 can be a smart phone, or other programmable cellular device such as tablet computer or laptop computer. The customer cell phone 902 hosts a client application 908 that acts as a client for the payment service. The client application 908 can communicate with the payment service via SMS using an SMS interface 910, or via TCP IP using a web interface 912.

As part of the registration process, the customer 904 submits a phone number for registration to the client application 908. The client application 908 validates that the phone number submitted by the customer 904 matches the phone number assigned to the customer cell phone 902 as determined by a SIM card 914 installed in the customer cell phone 902. The client application 908 generates a one-time-use code, and sends the one-time-use code to the payment service via the SMS interface 910. The SMS message is sent to a phone number monitored by the payment service. The payment service receives the SMS message and identifies the phone number that sent the SMS message. The identified phone number matches the phone number assigned to the customer cell phone 902 by the SIM card 914. If the phone number submitted by the customer 904 matches the phone number identified as the source of the SMS message, the payment service stores the identified phone number in association with the one-time-use code in a list of key-value pairs, or a relational database table. If the phone number submitted by the customer 904 does not match the phone number identified as the source of the SMS message, the one-time-use code is not stored and may not be used to complete the registration process.

To complete the registration process, the client application 908 collects registration information from the customer 904 including a phone number to register, a customer name, a customer billing address, and financial account information. The registration information is submitted along with the one-time-use code to the payment service via an HTTP secure connection. The payment service looks up the phone number stored in association with a onetime-use code and confirms that the stored phone number matches the phone number submitted with the registration information. If the stored phone number does not match the phone number submitted with the registration information, the registration request is denied. Otherwise, the registration is successful and the registration information is used to register the customer 904 with the payment service. The payment service notifies the customer 904 that the registration is successful via an HTTP secure message sent to the client application 908.

After successful registration, the client application 908 reads the SIM ID, MSID and IMEI of the customer cell phone 902, and encrypts the information with AES using a cryptographic key maintained by the client application 908. The encrypted information is sent to the payment service and stored in association with the customer's registration information. As part of successive login attempts, the encrypted information is returned from the server to the client application 908. The client application 908 decrypts the encrypted information and confirms the SIM ID, MSID, and IMEI of the customer cell phone 902 against the values returned by the payment service. If any of the values do not match, the client application 908 denies the login attempt.

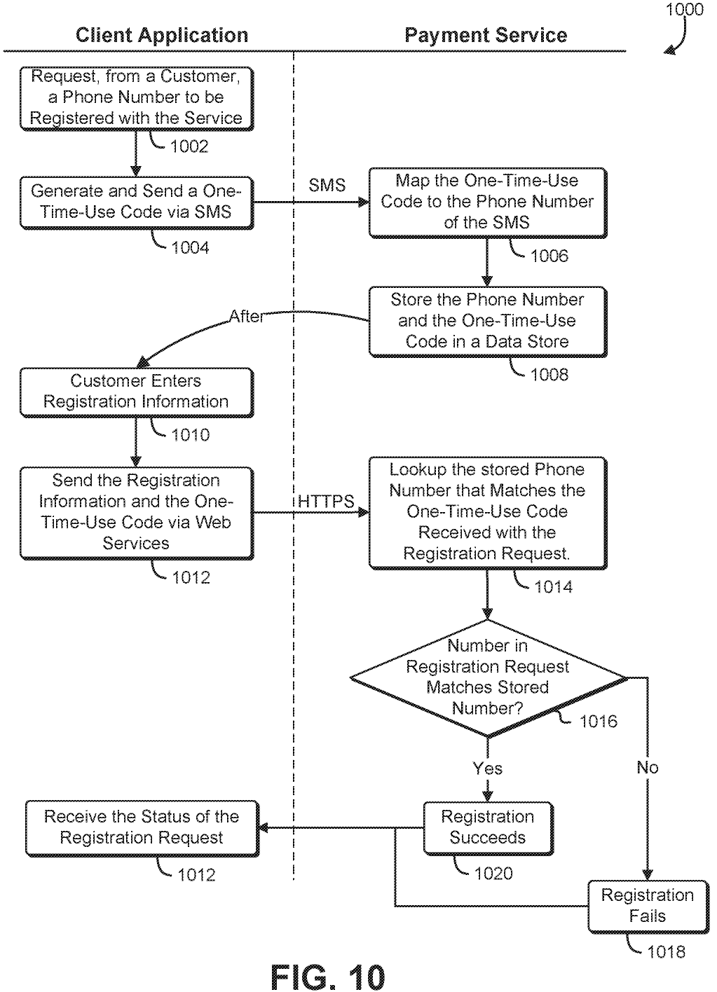

FIG. 10 shows an illustrative example of a process that, when performed by a customer cell phone and a payment service, confirms that a phone number provided by a customer matches a phone number associated with the customer cell phone. A swim diagram 1000 shows a process that begins at block 1002 where a client application running on a customer cell phone requests, from a customer, a phone number to be registered with the payment service. The customer can submit the phone number via a dialog box or text entry interface presented by the client application, a numeric keypad on the customer cell phone, or via a voice interface. At block 1004, the client application generates a one-time-use code. The one-time-use code can be a globally unique identifier (“GUID”), a random sequence of numbers, or an alphanumeric sequence. In one example, the one-time-use code is a random 16-digit alphanumeric sequence. The client application sends the customer-submitted phone number and the one-time-use code to the payment service via an SMS message. In some implementations, the content of the SMS message is encrypted with a public cryptographic key of a public-private cryptographic key pair. The private key of the public-private cryptographic key pair is accessible to the payment service. In another implementation content of the SMS message is encrypted with a symmetric cryptographic key available to both the client application and the payment service.

The payment service receives the SMS message from the client application, and if necessary, decrypts the SMS message using an appropriate cryptographic key. At block 1006, the payment service determines the phone number from which the SMS message was sent. The phone number from which the SMS message was sent may be identified by examining the SMS message header. If the phone number from which the SMS message was sent does not match the phone number received in the body of the SMS message, the SMS message is discarded and the registration process is terminated. If the phone number from which the SMS message was sent matches the phone number received in the body of the SMS message, the payment service maps the one-time-use code to the received phone number, and stores 1008 the phone number in association with the one-time-use code in a data store, list of key-value pairs, or table. In some implementations, the customer does not enter a phone number to be registered and the client application does not include a phone number in the body of the SMS message. The payment service determines the phone number of the sender of the SMS message, and stores the phone number of the sender of the SMS message in association with the one-time-use code.

After the payment service has recorded the one-time-use code and phone number, the client application prompts the customer to enter registration information. The customer enters 1010 the registration information on the customer cell phone using a user interface provided by the client application. At block 1012, the client application sends, to the payment service, the registration information and the one-time-use code via a TCP/IP link between the client application and the payment service. In some examples, the registration information is sent over an LTE link. In another example, the registration information is sent over a Wi-Fi connection. In yet another implementation, the registration information is sent over a Bluetooth connection.

The payment service receives the registration information from the client application, and looks up 1014, the phone number associated with the one-time-use code. If the payment service does not have a record of the one-time-use code, then the phone number provided in the registration information cannot be validated, and the registration request is denied. In some implementations, the payment service maintains a timeout for the one-time-use code. If the timeout associated with the one-time-use code has expired, the registration request is denied. If the payment service has a record of the one-time-use code, the payment service confirms 1016 that the phone number provided with the registration information matches the phone number associated with the one-time-use code, and then removes the onetime-use code from the database so that it cannot be reused. If the phone number provided with the registration information does not match the phone number associated with one-time-use code, execution proceeds to block 1018, and the registration request is denied. If the phone number provided with the registration information matches the phone number associated with the one-time-use code, execution proceeds to block 1020 and the registration request is granted by the payment service.

The payment service sends a notification to the client application indicating the status of the registration request. At block 1012, the client application receives the notification indicating the status of the registration request. The notification may be transmitted via SMS, or via a TCP/IP link between the client application and the payment service.

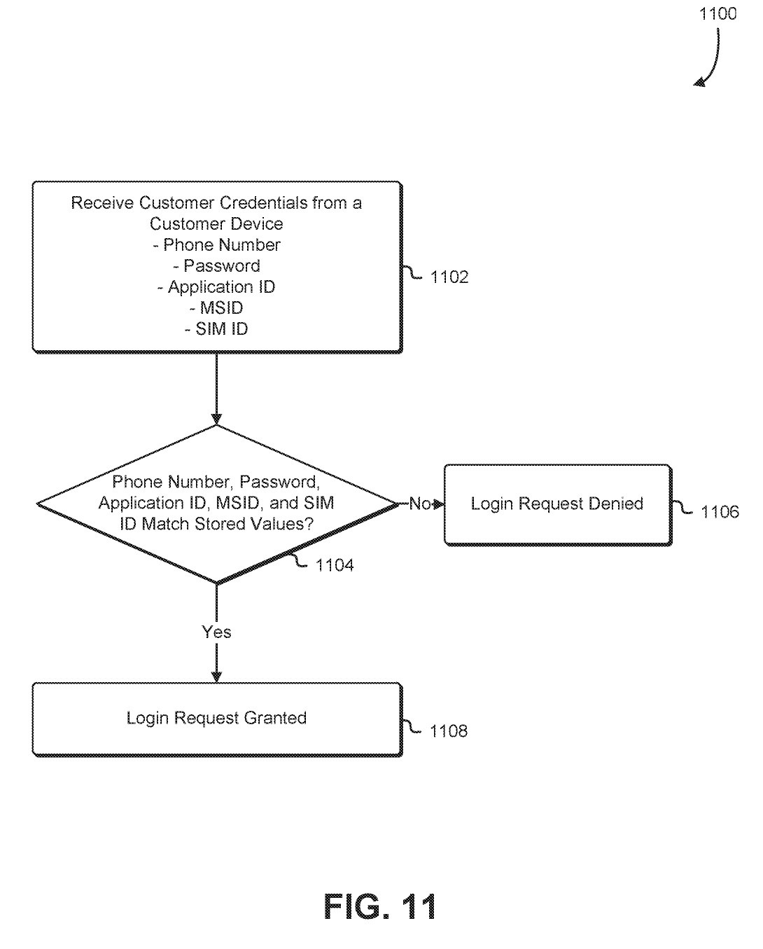

FIG. 11 shows an illustrative example of a process that, when performed by a payment service, processes a login request from a customer cell phone. A process diagram 1100 shows a process that begins at block 1102 with a payment service receiving a login request from a customer device. The login request specifies a phone number and a password. The phone number may be provided in the body of a message sent over a TCP/IP connection or in the header of an SMS message that includes the password. The password is encrypted while in transmission. In some examples, the password is encrypted with triple DES. In another example, the password is converted to a hash value using an MD5 algorithm. The payment service receives a set of encoded information from the customer device. The set of encoded information includes an application ID, an MSID, and a SIM ID.

At decision block 1104 the payment service looks up a stored password associated with the phone number provided with the login request, and determines whether the stored password matches the password provided with the login request. In some implementations, the payment service maintains a list of password hashes that are compared to a password has received with the login request, and passwords are compared by comparing their associated hash values. If the stored password does not match the password provided with the login request, execution proceeds to block 1106 and the payment service denies the login request. The payment service decodes the set of encoded information received from the customer device, and at decision block 1104, confirms that the set of encoded information matches information captured by the payment service at the time the customer device is registered. If the set of encoded information does not match the information captured at the time of registration, execution advances to block 1106 and the login request is denied. If the set of encoded information matches the information captured at the time of registration, the login request is granted 1108. Even if a customer's username and password are compromised, it can be difficult for an attacker to gain access to the customer's account on the payment service because the attacker's device will have a different application ID, MSID, and SIM ID.

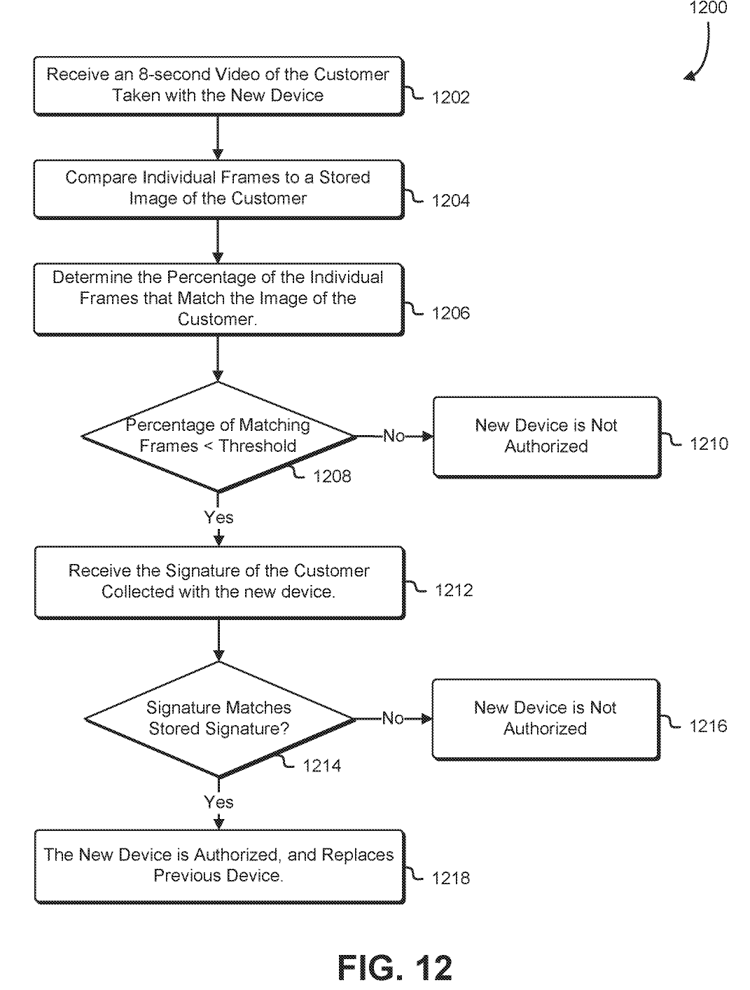

FIG. 12 shows an illustrative example of a process that, when performed by a payment service, confirms the identity of a customer and authorizes a replacement device. A process diagram 1200 shows a process that begins at block 1202. Using the replacement device, the customer takes an 8-second video clip of their face, and sends the 8-second video clip to the payment service. The payment service receives the 8-second video clip. The payment service splits the 8-second video clip into a number of still images. The images are compared 1204 to an image of the customer stored by the payment service during the initial registration processes, and each image is assigned a numerical score indicating the image's similarity to the image retained by the payment service. At block 1206, the application determines how similar the set of images are to the image retained by the payment service by determining a percentage of the images that have an associated numerical score that exceeds a threshold value. At decision block 1208, if the percentage of the images that have an associated numerical score that exceeds a threshold value is less than a percentage threshold determined by the administrator of the payment service, execution proceeds to block 1210 and the replacement device is not authorized for use with the payment service. If the percentage of the images that have an associated numerical score that exceeds a threshold value is greater than or equal to the percentage threshold, the 8-second video clip is determined to be a valid video clip of the customer, and execution proceeds to block 1212. In one example, images are assigned a numerical score in the range of 1 to 100. Images that score higher than 70 are determined to be matching the stored image, and 65% of the still images must be matching to determine that the video clip is a video clip of the customer.

A signature is generated by the customer on the replacement device by signing, with a finger or stylus, a touch screen on the replacement device. An application on the replacement device transfers a digital representation of the signature to the payment service. The digital representation may be an image, a pressure signature, or a hashed representation. At block 1212, the payment service receives a signature from the replacement device. The payment service compares the digital representation of the signature received from the replacement device to a corresponding digital representation of the signature collected during the initial registration process of the customer. At decision block 1214, if the payment service determines that the signature submitted by the replacement device does not match the signature retained during the initial registration process, the replacement device is not authorized for use with a payment service. If the payment service determines that the signature submitted by the replacement device matches the signature retained during the initial registration process, the payment service authorizes the replacement device, and updates the registration information of the customer accordingly.

In some examples, verification of the identity of the customer is improved by comparing a plurality of still images taken from the video clip with an image captured during the initial registration process. The payment service may also utilize one or more security questions provided by the customer during the initial registration process. If the security questions are answered correctly, the replacement device may be authorized.

In certain environments, a customer may replace an original device of one type with a replacement device of a different type. If the replacement device is of a different type, the payment service verifies that the SIM used in the replacement device is the same as the SIM used in the original device. If the original device and the replacement device share a common operating system or underlying framework that allows direct access to phone parameters (such as an Android to Android conversion), the payment service acquires and confirms that phone-identifying parameters such as the SIM ID and the MSID match those of the original device. If the original device and the replacement device use an operating system that does not allow direct access to phone parameters (such as an IOS to IOS conversion), device parameters for the replacement device may be acquired by at least in part prompting the customer to enter the SIM ID of the replacement device, and sending, from the replacement device to the payment service, an SMS message that includes a random number. Device parameters of the replacement device may be extracted when the SMS message is received by the payment service.

In another example, registration of the replacement device may be authorized by sending a one-time-use pass code (“OTP”) in an email addressed to the customer. The email address of the customer is saved by the payment service during the initial registration process. The customer is required to provide the OTP when activating the replacement device. In some implementations, the customer may be asked to provide additional information such as passport information, family information, date of birth, or other verifiable personal information as a condition of activating the replacement device.

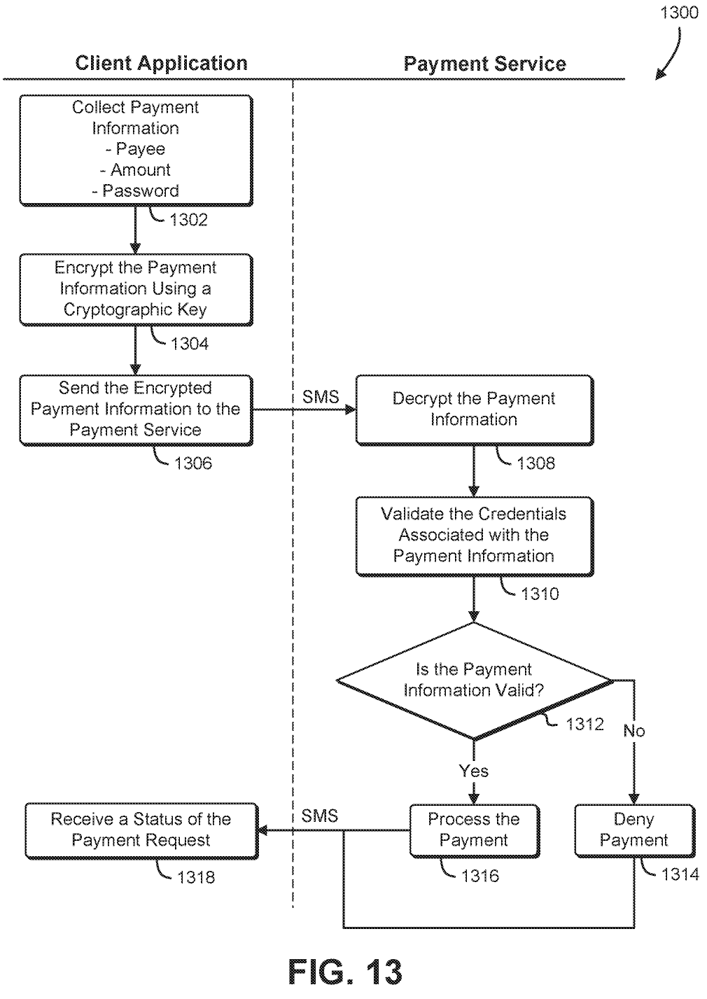

FIG. 13 shows an illustrative example of a process that, when performed by a client application on a customer cell phone and a payment service, submits and validates a payment request via SMS. A process diagram 1300 illustrates a process that begins at block 1302 with a client application collecting payment information from a customer. The payment information includes a payee identified by a payee phone number, an amount of payment, and a password set by the customer as part of the customer registration process. The client application encrypts 1304 the payment information using a cryptographic key. In some examples, the payment information is encrypted using an asymmetric cryptographic algorithm and a public key of a public-private key pair. In another example, the payment information is encrypted using symmetric cryptography and a symmetric key. At block 1306, the client application sends the encrypted payment information to the payment service in an SMS message.

At block 1308, the payment service receives and decrypts the encrypted payment information. The payment service validates the credentials included in the payment information by at least in part identifying the customer based on the originating phone number of the SMS message, and confirming that the password supplied with the payment information matches the customer's password. At decision block 1312, the payment service determines if the payment information is valid. In some examples, the payment service verifies that the customer has sufficient funds to fulfill the payment request. In some examples, the payment request includes a transaction ID, a transaction number and a geo location of the customer's device. The payment service validates the format sequence of the transaction id and transaction number, and verifies that the transaction geo location is within a permitted area. The permitted area may be determined based at least in part on a previously reported geo location. If the time between the previously reported geo location and the current time, and the distance between the previously reported geo location and the currently reported geo location indicates that the customer's device has moved faster than an allowable threshold, the transaction may be denied. The allowable threshold may be determined by assuming that a customer may not travel at a speed in excess of the prevailing automotive traffic (for example 60 miles an hour) between two purchase points.

If the customer does not have sufficient funds in the payment service to fulfill the request, the payment service may attempt to transfer funds from an external financial institution to the payment service. The payment service verifies that the payee phone number is a valid phone number, and that the payee identified in the payment information is registered with the payment service. In some examples, if the payee is not registered with the payment service, the payment service generates a provisional account for the payee and holds the received funds in trust. The payee is notified that funds are available via an SMS message sent to the payee phone number. The SMS message includes a one-time-use code generated by the payment system. The payee may claim the provisional account by registering with the payment service, and providing the one-time-use code.

If the payment system determines that the payment information is not valid, the payment request is denied 1314. If the payment system determines that the payment system is valid, the payment system allows 1316 the payment, and fulfills the payment request by transferring funds in the requested amount from the customer to the identified payee. An SMS message is sent by the payment service to the client application communicating the payment status. At block 1318, the client application receives the SMS indicating the state of the payment.

In some implementations, the SMS message that includes the payment request is encrypted with a private key which is known to the client application and the payment service without requiring an exchange of cryptographic keys. The private key is changed after each transaction. In some examples, the transaction SMS is signed using the private key of a public/private key pair owned by the client, and verified using a public key in a digital certificate provided to the server by the client. If the payment is successfully processed notifications are sent to the customer and the payee via SMS.

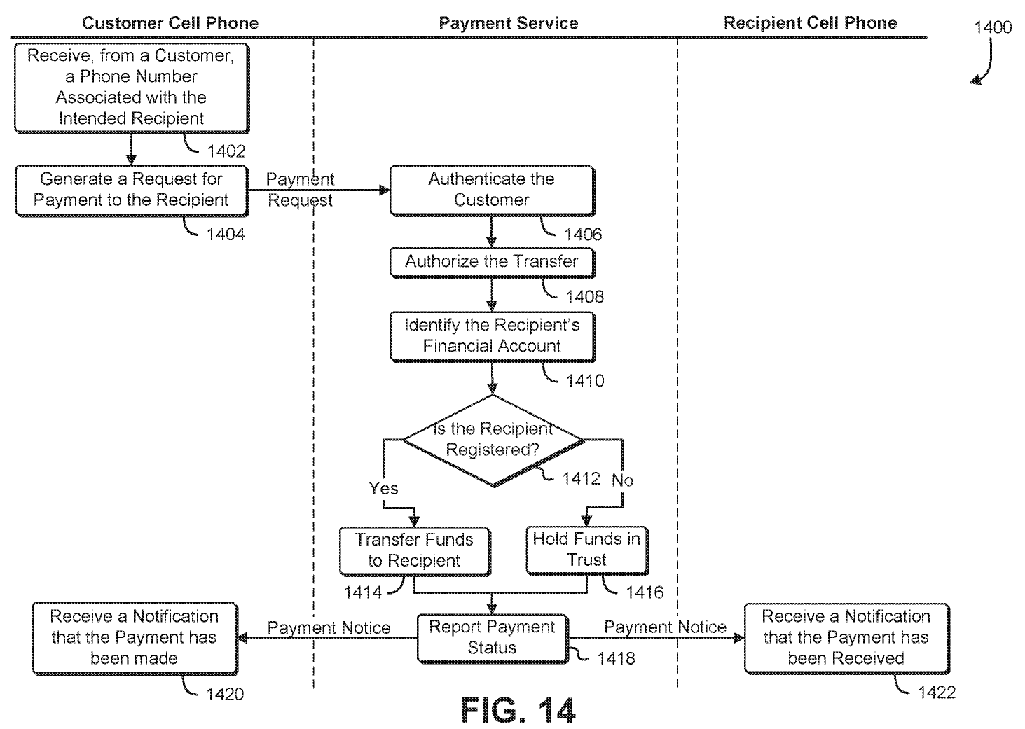

FIG. 14 shows an illustrative example of a process that, when performed by a customer cell phone, a payment service, and a recipient cell phone, processes a payment request sent from the customer cell phone to the a recipient that is identified with a phone number. A swim diagram 1400 illustrates a process that begins at block 1402 where a customer, operating a customer cell phone, enters a payment request comprising a phone number associated with an intended payee, and an amount of payment. An application running on the customer cell phone generates and sends 1404 the payment request in the form of an SMS message or a data packet sent via an HTTP secure connection.

The payment service receives the payment request at block 1406, and authenticates the identity of the customer that submitted the request. In some examples, the customer is authenticated using a password included with the payment request. In another example, the customer is authenticated based at least in part on a phone number extracted from an SMS message. In yet another example, the customer is authenticated based at least in part on a network address of the sender. In yet another example, the customer is authenticated using a digital signature included with the payment request, and the digital signature is authenticated using a public key from a digital certificate associated with the customer. If the payment service is unable to authenticate the customer, the payment request is denied. At block 1408, the payment service determines whether the payment request is authorized. The payment request may be authorized by confirming that the customer has sufficient funds to fulfill the payment request, and that the phone number of the intended recipient is a valid number. If the payment service is unable to determine that the payment request is authorized, the payment request is denied.

At block 1410, the payment service attempts to identify the recipient based at least in part on the phone number supplied by the customer. If the payment service locates a registered account on the payment service with the phone number that matches the payee phone number supplied by the customer, the payment service transfers 1414 the designated payment amount to the identified recipient. If the payment service is unable to identify an account on the payment service with a phone number that matches the payee phone number supplied by the customer, the payment service determines 1412 that the intended recipient is not registered with the payment service, and execution proceeds to block 1416. At block 1416, the payment service generates a provisional account with a phone number that matches the payee phone number. The payment amount is transferred from the customer to the provisional account. An SMS message is sent 1418 to the pay phone number indicating that funds have become available on the payment service, and indicating how they may be claimed. In some examples, the SMS message includes a one-time-use code which is provided by the payee to claim the funds. A notification is sent to the customer cell phone notifying the customer that the funds have been transferred to a provisional account. In some examples, the customer is given an option to recall the payment until the funds have been claimed by the recipient. When the intended recipient claims the funds, notification may be sent to the customer indicating that the funds have been claimed.

At block 1420, the customer cell phone receives the notification from the payment service indicating that the payment has been made to the recipient. At block 1422, the recipient cell phone receives the notification from the payment service indicating that a payment has been received.

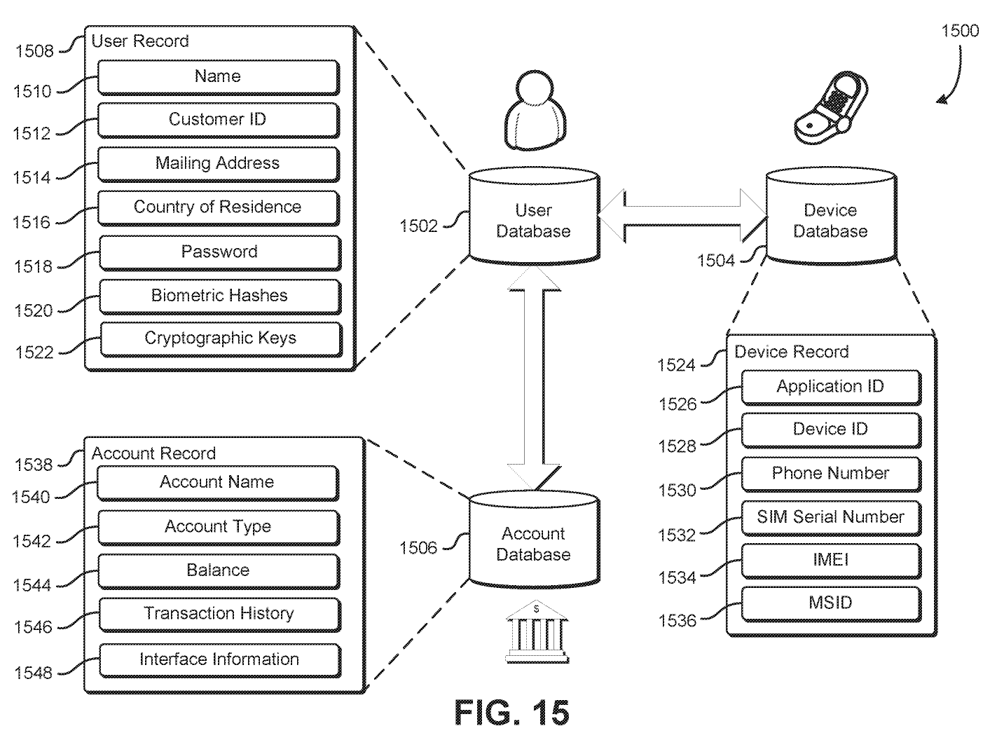

FIG. 15 shows an illustrative example of a data structure for maintaining user, device, and account information associated with a payment system. A data diagram 1500 includes a user database 1502, a device database 1504, and an account database 1506 which are maintained as part of a payment service. Records and the device database 1504 and records in the account database 1506 are linked to a particular record in the user database 1502. For example, a particular registered user record in the user database 1502 may be linked to a number of device records in the device database 1504 and a number of account records in the account database 1506. In one implementation, the user record 1508 includes a number of pointers to device records and a number of pointers to account records.

The user database 1502 maintains information associated with customers that are registered to use the payment service. The user database 1502 includes a user record 1508 for each registered customer. The user record 1508 includes a number of fields for holding information related to the registered customer. A name field 1510 holds the name of the customer. A customer ID field 1512 maintains an identifier used to identify the user record 1508. The customer ID is generated by the payment service as a result of the customer registration process. The customer ID may take the form of a GUID, Number, or an alphanumeric identifier that is unique to each registered customer. A mailing address field 1514 holds the mailing address of the registered customer. The mailing address may include a street address, a city, state, and a post office box identifier. A country field 1516 indicates the country of residence for the registered user. The information in the country field 1516 may be used to apply applicable financial regulations, and to identify local currencies used by the registered user. Password field 1518 is used to retain password information for the registered customer. In some implementations, the password information is stored in the form of an encrypted version of a password specified by the registered customer. In another example, password information is stored in the form of a cryptographic hash of a password specified by the registered customer. Biometric hash field 1520 records biometric information used to authenticate the identity of the registered customer. In some examples, the biometric information includes an image, metric, or hash associated with a signature submitted by the registered customer. In another example, the biometric information includes an image, metric, or hash associated with a fingerprint of the registered customer. In yet another example the biometric information includes an image, metric, or hash associated with a retina scan or a voiceprint of the registered customer. A cryptographic key field 1522 retains cryptographic keys associated with the registered customer. The cryptographic keys may include a digital certificate and private key for the registered customer, a public-private key pair for the registered customer, or a symmetric key used by the registered customer. In some examples, the password is a pattern associated with a pattern like. In such examples, the pattern may be stored as a cryptographic hash of the pattern, or an encoded description of the pattern.

The device database 1504 maintains information that describes devices used by registered customers. The device database 1504 includes a device record 1524 for each customer device. The device record 1524 includes a number of fields for holding information related to the customer device. An application ID field 1526 includes an identifier that is associated with an installed instance of a client application on the customer device. The application ID may be generated by the client device when the application is installed or by the payment service when the application connects to the payment service. Each active instance of the client application is assigned a unique application ID. A device ID field 1528 stores an identifier that is associated with the customer device. The device ID is assigned by the payment service via the client application. A phone number field 1530 retains a phone number associated with the customer device. The phone number is determined when the customer registers the device with the payment service. A SIM serial number field 1532 retains a SIM serial number associated with a SIM card installed in the customer device. The SIM serial number is captured during the registration process. An IMEI field 1534 contains the IMEI of the customer device and an MSID field 1536 contains the MSID of the customer device. The IMEA and MSID of the customer device are captured and stored by the payment service during the registration process.

The account database 1506 maintains information that describes accounts associated with the registered customers. The accounts may include bank accounts and credit accounts used to transfer funds into the payment system, bank accounts or savings accounts used to extract funds from the payment system, and merchant accounts, utility accounts, and transportation accounts from which goods and services may be purchased. The account database 1506 includes an account record 1538 for each account used by a particular customer. The account record 1538 includes a number of fields that hold information used by the payment service to fulfill transactions involving the account. An account name field 1540 includes information that provides a human-readable description of the account. An account type field 1542 identifies the type of the account. Account types may include bank accounts, credit accounts, merchant accounts, transportation accounts, cellular service provider accounts, and stock accounts. A balance field 1544 maintains the current balance of the associate account. A transaction history field 1546 is used to maintain a history of transactions performed with the account. An interface information field 1548 includes information used interface with the account such as a URL, phone number, external account number, account password, username, and cryptographic key used to access the external account.

In some implementations, the payment service maintains a record of each payment made in association with a geo location of the recipient. In addition, a record of each party in a transaction chain associated with the payment is maintained. The transaction chain may be limited to a specified number of parties. In some examples, the transaction chain is terminated when the payment reaches a bank, financial institution, or other trusted entity.

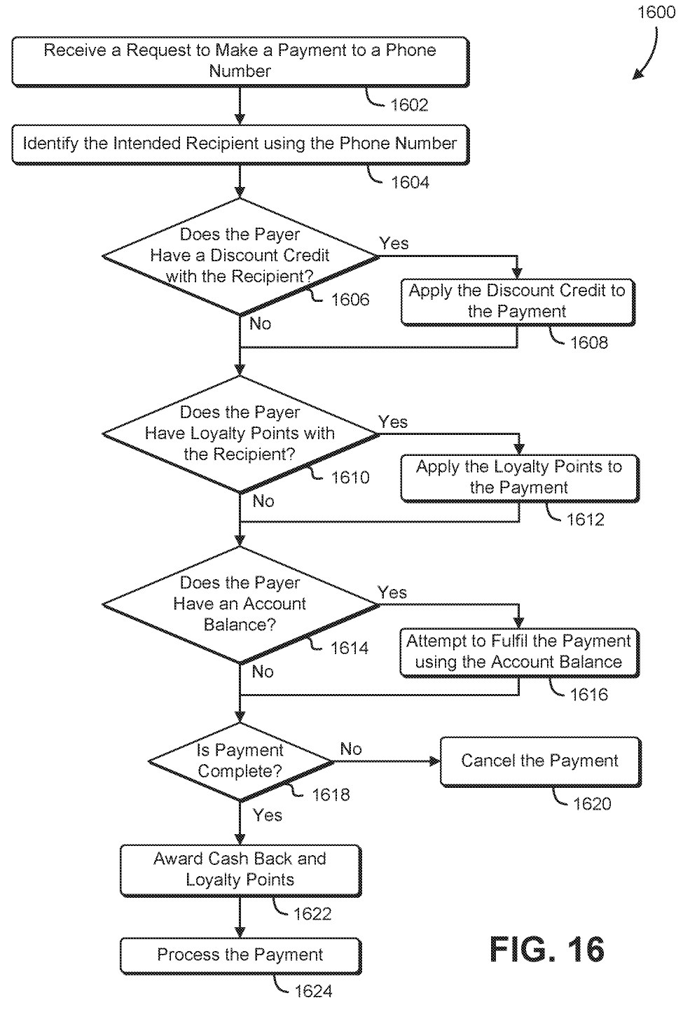

FIG. 16 shows an illustrative example of a process that, when performed by a payment service, processes a payment request using a combination of payment sources. A process diagram 1600 shows a process that begins at block 1602 with a payment service receiving a payment request, from a client application running on a registered customer device, to make a payment of a designated amount to a recipient identified by a recipient phone number. The payment request may be received via an SMS message, or via an HTTP secure, HTTP, or TCP/IP connection between the payment service and the client application. At block 1604, the payment service identifies the recipient in a database of registered customers of the payment service based at least in part on the recipient phone number included with the payment request.

The payment service performs a number of checks to determine whether the payment request can be fulfilled. At decision block 1606, the payment service identifies the customer that submitted the payment request, and determines whether the customer has a discount credit with the recipient. The payment service queries the list of accounts associated with the customer, and determines whether list of accounts includes a discount credit account with the recipient. If an appropriate discount credit account is located, the payment service applies 1608 funds from the balance of the discount credit account to the amount of the pending payment request. At decision block 1610, the payment service determines whether the customer has loyalty points with the recipient. The payment service queries list accounts associated with the customer, and determines what the list of accounts includes a loyalty point account with the recipient. If an appropriate loyalty point account is located, the payment service applies 1612 loyalty point rewards from the balance of the loyalty point account to the pending payment request. Loyalty point rewards may be awarded in the form of a percentage discount of the total transaction, or a monetary conversion from points to the currency used for the transaction. At decision block 1614, the payment service determines whether the customer has an active payment account registered with the payment service. If the customer has an active payment account registered with a payment service, the payment service attempts to fulfill 1616 the remaining balance of the payment request by first debiting the internal payment service account associated with the customer. If the funds in the internal payment service are not sufficient to fulfill the payment request, the payment service attempts to use an external account linked to the customer such as a bank, credit account, or credit card. The order of funding from external accounts may be defined by the customer during the registration process.

At decision block 1618, the payment system determines if the total amount of funds available from discount credits, loyalty points, internal accounts and external accounts is sufficient to fulfill the payment request. If the customer's total funds are insufficient, execution proceeds to block 1620 and the payment service cancels the payment and all accounts associated with the customer and recipient remain unchanged. If the customer's total funds are sufficient to fulfill the transaction, execution proceeds to block 1622 and the payment service awards, to the customer, applicable cash back and loyalty point rewards defined by a recipient payment policy. In various examples, the recipient may define a percentage of cash back, an award of discount credit, or loyalty point toward in exchange for the transaction. At block 1624, the payment service processes the payment and fulfills the payment request by first debiting discount credits, loyalty points, and then account balances. Funds transferred from the customer are credited to the recipient's payment service account. In some examples, the recipient may define an external account to receive funds, such as a bank account.

In some examples, a merchant may have insufficient credit with the payment service to satisfy a customer payment that includes discount credits, loyalty points; cash back credits, or other incentives. If the payment service detects that a merchant does not have sufficient credit to cover the cost of the incentives, the payment service determines whether the customer has sufficient funds, and processes the payment is in customer funds. The amount and type of incentives that were unable to be redeemed are reported to the customer, so that the customer may contact the merchant to resolve the issue.

In some examples, payments may be made between two customers in exchange for talk time on a mobile device. In such examples, a seller of talk time enters an amount of talk time available for purchase, and an associated price for the amount of talk time. The amount of talk time available for purchase and the associated price are uploaded to the payment service. Other payment customers are able to view the sellers offer to sell talk time. If a buyer accepts the offer to sell talk time, the payment service transfers is sufficient amount of funds from the buyers account to a holding account maintained by the payment service, and sends a notification to the seller that the talk time has been purchased. The payment service monitors talk time transferred from the seller to the buyer, and after the payment service confirms that the amount of talk time has been transferred from the seller to the buyer, the payment service transfers the funds from the holding account to the seller.

In another example, the customer may make a payment to a telecommunications provider for the purpose of purchasing additional airtime. The telecommunications provider registers with the payment service. When the customer makes a payment to the payment service and indicates that the payment is for the purpose of purchasing additional airtime, the payment service identifies the phone number associated with the customer device. Based at least in part on the customer's phone number, the payment service identifies a particular telecommunications provider associated with the customer's device, and transfers the payment from the customer's account to the particular telecommunications provider's account. In some implementations, the payment service determines when a customer's balance with the particular telecommunications provider falls below a threshold amount, and notifies the customer that additional funds are needed.

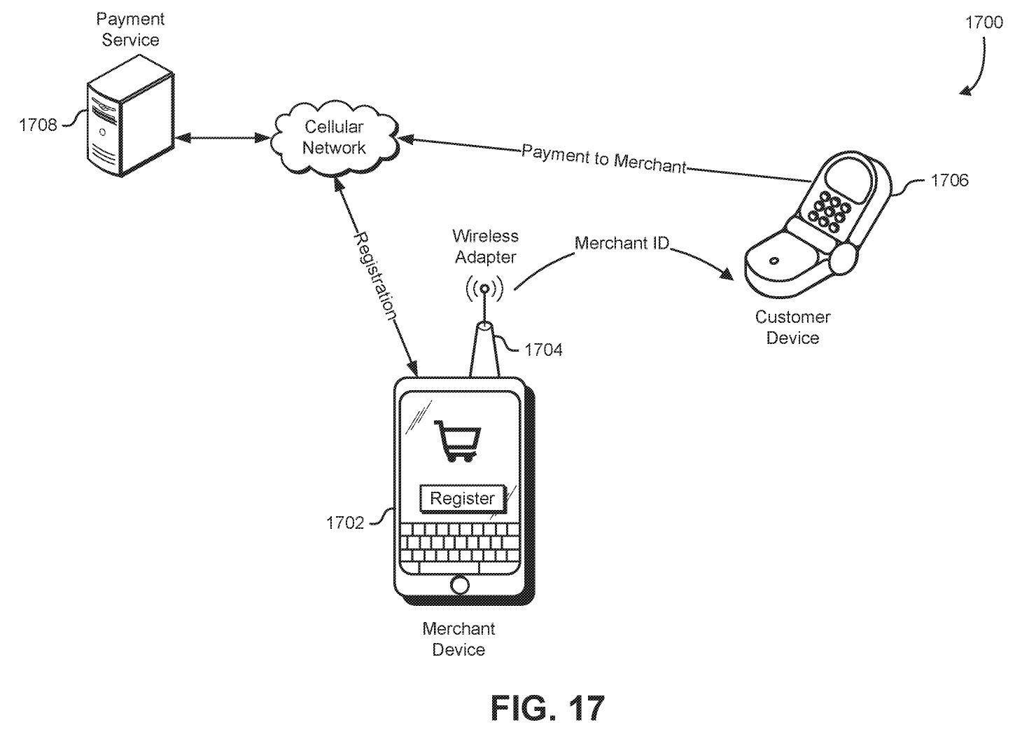

FIG. 17 shows an illustrative example of an environment that broadcasts payment information from a merchant device to prospective customer devices. An environment 1700 includes a merchant device 1702 that includes a wireless adapter 1704. The merchant device 1702 can be a smart phone, a cell phone, a tablet computer, or personal computer. The wireless adapter 1704 can be a Bluetooth or 802.11 Wi-Fi adapters. Using the wireless adapter 1704, the merchant device 1702 broadcasts a wireless discovery signal that can be received by a customer device 1706. The discovery signal may be a station ID associated with a wireless hotspot feature supported by the wireless adapter 1704. In some examples, the discovery signal is a station ID a wireless hotspot broadcasted by the wireless adapter 1704. In another example, the discovery signal is a device ID broadcast by the wireless adapter 1704 using the Bluetooth protocol. The customer device 1706 can be a cell phone, smart phone, or handheld wireless device that is able to receive signals from the wireless adapter 1704.

The merchant device 1702 registers with a payment service 1708 by communicating over a cellular network. As part of the registration process, the merchant device 1702 registers a phone number with the payment service 1708. If a customer operating the customer device 1706 moves within range of the wireless adapter 1704, the customer device 1706 detects the wireless discovery signal. The wireless discovery signal is used by the customer device 1706 to identify the phone number registered by the merchant device 1702. If the customer initiates a payment with the customer device 1706, the phone number registered by the merchant device 1702 is auto populated into a payment form used by the customer on the customer device 1706. In this way, the chances of a data entry error are reduced.

Auto Payment is a feature that allows a merchant to receive payment from customers without firmly or manually sharing the merchant's mobile number. The feature operates using short-range wireless communications such as Bluetooth and Wi-Fi. To activate the Auto Payment feature, the merchant saves their business location within a merchant application running on the merchant device 1702. The merchant application saves the network cell ID's, GPS Coordinates and Wi-Fi signals to define their business area.

The client application running on the customer device 1706 uses this information for identifying the business location and whenever the application determines that the device has entered the saved merchant location, it will automatically turn on the Bluetooth and hotspot (if Wi-Fi is not turn on) and will share business contact details through the Bluetooth/hotspot name. When a customer enters the merchant's location and opens the application, the application searches for the merchant's broadcast signal and suggests, to the customer, nearby merchants with whom the customer can conduct transactions.

When the merchant enters the area saved as his or her business location, the application enables the short range wireless communication feature on the merchant's payment device. When the merchant leaves the area saved as his or her business area, the wireless communication feature on the merchant's payment device is disabled. Whenever the merchant starts broadcasting, the information is sent to the payment service 1708. The payment service 1708 records the merchant as being active. When the merchant exits the zone, a notification is sent to the payment service 1708 and the merchant is marked as inactive. Customers are able to interrogate the payment service to identify active merchants in their area. For example, a customer may inquire to the payment service whether a particular merchant is open.

In various implementations, the wireless discovery signal is encrypted. In one version of encryption, the integer value of every character in the source string is added to the index value of the same character and then replaced with characters between A-J and a-k. Each character has a corresponding integer value, and each character of the discovery signal is replaced with its corresponding encoded character.

For decryption, a reverse of the encryption process is performed. We fetch the encoded characters and replace the characters with a corresponding numerical value. The index value of each character is subtracted from the corresponding numerical value to arrive at the original value.

When a customer logs in to the payment service 1708, a client application on the customer device 1706 scans, using the device's wireless hotspot scanning functions, for nearby Wi-Fi/Bluetooth signals which are compatible with the client application. The application scans all the discovery signals with encrypted information, extracts the phone numbers and business names from the encrypted information, and saves the decrypted information to memory.

When the customer makes a payment to the merchant, the saved information is presented to the customer in a pop-up along with the associated business name of each number, allowing the customer to choose the merchant name instead of typing an associated 10 digit phone number manually.

In some implementations, encryption is performed according to the following algorithm. In encryption, first we take the integer value of every character and add the index value with integer value of same character and then we are replacing with alphabets between A-J and a-k. Decryption is performed using the opposite logic of encryption. The encrypted characters are retrieved, converted to the corresponding constant values, and the payment service subtracts the index value of each character to arrive at the original value.

Encryption Example:

Mobile Number: 9792759971

Number: 9 7 9 2 7 5 9 9 7 1

Get Index Value: 0 1 2 3 4 5 6 7 8 9

Get Total 9 8 11 5 11 10 15 16 15 10

(Total=Index value+Corresponding digit)

Replace Alphabet: J I b F b a f g f a

Encrypted Mobile Number: JIbFbafgfa.

Characters from ‘A to ‘J’ are used for values 0 to 9 and characters ‘a’ to ‘k’ are used for values 10 to 20.

Decryption Example.

Encrypted Mobile Number: JIbFbafgfa.

Number: J I b F b a f g f a

Replace Number: 9 8 11 5 11 10 15 16 15 10

Get Index Value: 0 1 2 3 4 5 6 7 8 9

Subtract Index value: 9 7 9 2 7 5 9 9 7 1

(Subtract! on=Replaced number−Index Value).

In some examples, payment information may be derived based at least in part on a geo location associated with a payment request. Payments fulfilled by the payment service are stored in a transaction history along with an associated geo location. The Geo location may be determined in a variety of ways such as by using a GPS receiver, GLONASS, cell tower location, or Wi-Fi location services. If a customer frequently makes a payment to a particular merchant at a particular location, the application uses the transaction history to predict the payee's phone number making it easier for the customer to complete a payment. When a new payment is initiated, the device identifies previous transactions that were initiated within a threshold distance of the current location of the payment device. The collection of previously used payees is presented to the customer, with the default value being the most frequently used payee. In another implementation, the default value is the most recently used payee within the set of identified transactions near the current location.

In some implementations, geo location is based on cell tower identification. The payment service maintains a database of cell tower details along with associated GPS details. When the customer logs into the client application using the customer device 1706, and the GPS receiver is unable to receive geo location data, the client application determines a geo location using the cell tower ID data maintained by the payment service.

In some examples, the merchant is able to use the payment service 1708 to generate a merchant website using the merchant device 1702. When the merchant registers with the payment service, the merchant provides information that identifies a business category to the payment service. The payment service maintains a database with a collection of business templates, each template in the collection of business templates associated with an individual business category. Using a template associated with the business category identified by the merchant, the payment service generates a template website for the merchant. The merchant updates the template website to produce a final website for the merchant.

Customers of the payment service may contact the payment service 1708 using the customer device 1706, and retrieve a list of merchants near a geo location associated with the customer device 1706. By selecting the merchant from the list of merchants, a particular customer is provided with the information in the final website of the merchant.

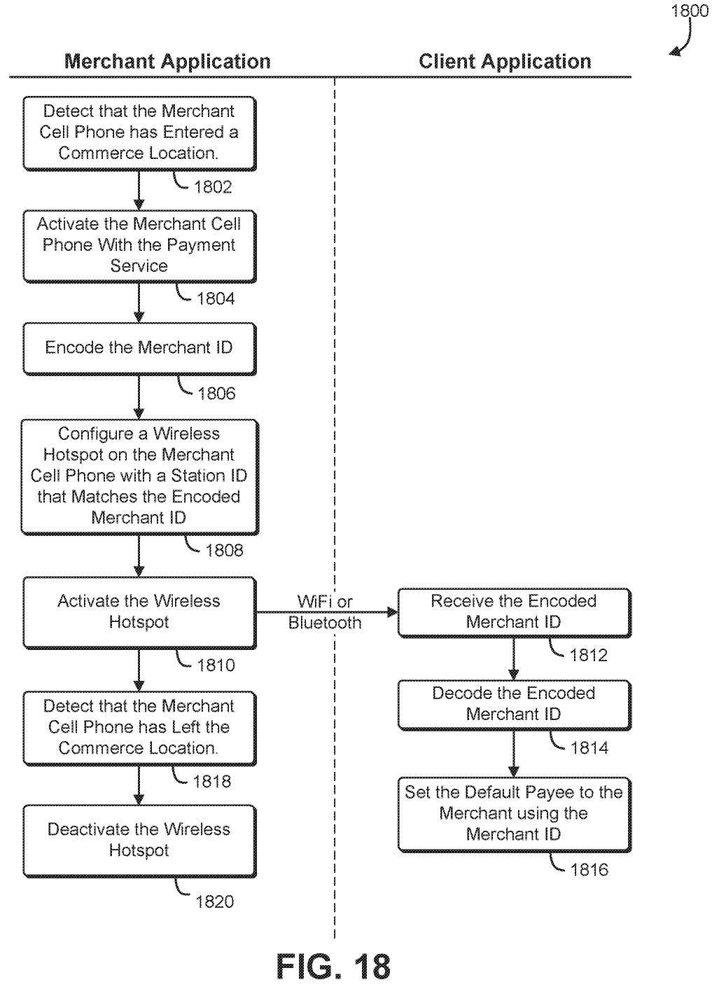

FIG. 18 shows an illustrative example of a process that, when performed by a merchant cell phone and a customer cell phone, activates a merchant terminal when the merchant cell phone enters a commerce location, and broadcasts default payment information to the customer cell phone via a wireless hotspot. A swim diagram 1800 shows a process performed by a merchant application running on a merchant cell phone and a client application running on a customer cell phone. The process begins at block 1802 where the merchant application detects that the merchant cell phone has entered a business location defined by the merchant as the merchant's place of business. The merchant cell phone may determine the geo location of the cell phone using a GPS receiver, a GLONASS receiver, Wi-Fi location services, or cell tower location services. The merchant cell phone transmits the geo location of the merchant cell phone to the payment service which maintains a database of the merchant's business locations and indicates, to the merchant application, whether the merchant cell phone is near the merchant's business locations. If the payment service indicates that the merchant cell phone is near the merchant's business locations, the merchant application indicates 1804, to the payment service, that the merchant is active. At block 1806, the merchant application encodes the merchant ID and payment information as described above in the description of FIG. 17. The encoded merchant ID and payment information is used to configure 1808 a wireless interface on the merchant cell phone. In some examples, an 802.11 wireless hotspot is configured having a station ID equal to the encoded merchant ID and payment information. In another example, a Bluetooth station is configured with a station ID equal to the encoded merchant ID and payment information. At block 1810, the merchant application activates the wireless interface on the merchant cell phone to activate the wireless hotspot.

If a customer with a customer cell phone enters within range of the wireless hotspot, the client application running on the customer cell phone receives 1812 the encoded merchant ID via the wireless hotspot. The client application decodes 1814 the encoded merchant ID and payment information. If the customer initiates a payment transaction, the client application presents, to the customer via the client application, the merchant ID and payment information so that the customer is not required to manually enter a phone number associated with the merchant. In some examples, the client application sets 1816 eight default payee based at least in part on the merchant ID and the payment information received via the wireless hotspot.

If the merchant device moves outside the merchant's place of business, the merchant application detects 1818 that the merchant cell has left the merchant's place of business and deactivates 1820 wireless hotspot. The merchant application contacts the payment service and notifies the payment service that the merchant is no longer active. The payment service records that the merchant is no longer active.

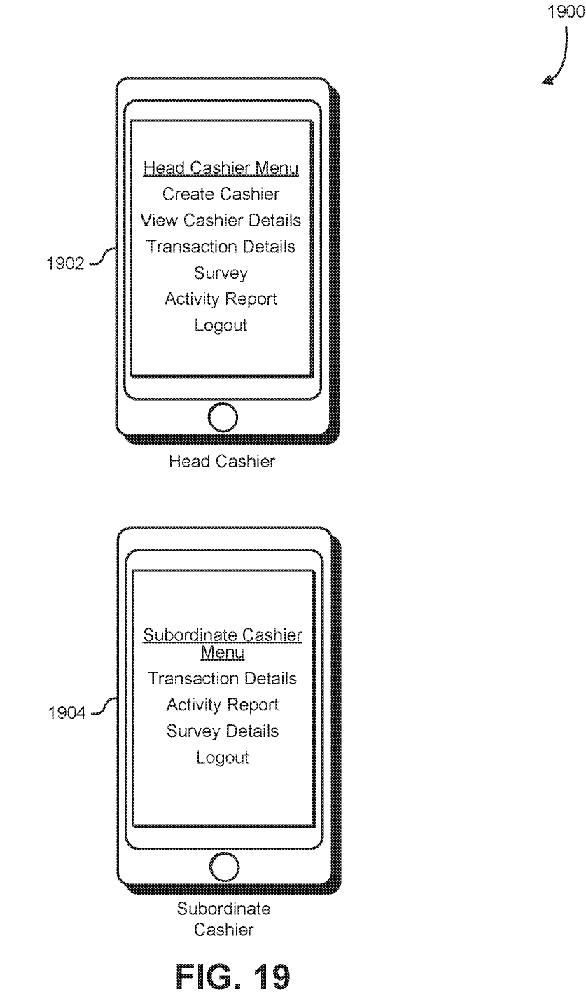

FIG. 19 shows an illustrative example of a device and menu usable by a head cashier and a device and menu usable by a subordinate cashier. A cashier-management system 1900 includes a head cashier device 1902 and a subordinate cashier device 1904. The head cashier device 1902 and the subordinate cashier device 1904 can be a cell phone, a smart phone, a personal digital assistant, a tablet computer, a personal computer, or a computer system running a web browser. In some examples, a business may appoint a head cashier that manages one or more subordinate cashiers. Using the cashier-management system 1900, a head cashier is able to register and manage one or more subordinate cashiers. The head cashier controls access to a business account on the payment system that retains sale proceeds. A subordinate cashier may processes sales transactions using the subordinate cashier device 1904. Proceeds that result from sales transactions conducted by subordinate cashiers are transferred to the account controlled by the head cashier (or the head-cashier account), and are not accessible to the subordinate cashier. Subordinate cashiers are prevented from accessing the business account controlled by the head cashier.

Using the head cashier device 1902, the head cashier may register one or more subordinate cashier devices with the payment service. A first part of the subordinate cashier registration process is performed by the subordinate cashier. The subordinate cashier registers the subordinate cashier device 1904, and enters the head cashier's phone number as a parent phone number. A notification is sent by the payment service to the head cashier indicating that the subordinate cashier is attempting to register a subordinate cashier device 1904. If the head cashier improves the request, the subordinate cashier device 1904 is configured, by the payment service to redirect payments to the head cashier. When the subordinate cashier receives the payment, notifications are sent to the subordinate cashier device 1904 and the head cashier device 1902 by the payment service.

The subordinate cashier device 1904 runs a cashier application which supports two sets of functionality: subordinate cashier functionality and head cashier functionality. Subordinate cashier functionality is accessed by logging in at a login screen provided by the cashier application using a set of subordinate cashier credentials. Head cashier functionality is accessed by logging in using a set of head cashier credentials. Subordinate cashier functionality provides access to the following application menu items.

Login Menu

Head Cashier Login

Subordinate Cashier Login

Main Menu

Registration Module

Login

Dash Board

Cashier Module

Activity Report

Transaction Module

Received Money

Broadcast Module

Counter Information

Survey Details

Cash Verification Module

Family Mode (Multiple Login)

Cash Collector Module

Logout

The registration module is used by the head cashier to register with the payment service. The head cashier provides their name, contact number, and RC, address details, and password to the payment service as part of the registration process. A dashboard is provided that allows users of the application to view activity reports, transaction reports, and for the head cashier, create and manage subordinate cashiers.

Subordinate cashiers are able to track their time by entering information into the subordinate cashier device 1904. The head cashier can view reports showing the amount of payments received by each subordinate cashier, and hours worked by each cashier. A survey module is accessible to both had cashiers and subordinate cashiers. The survey module provides transaction details in graphical format. The transaction details may be provided on an hourly, daily, weekly, or monthly basis. If the subordinate cashier also accepts cash payments, the payment service tracks the amount of available cash on hand for each subordinate cashier. When a cashier logs out the subordinate cashier enters the amount of cash currently in hand. When another cashier takes over the check stand, the current amount of cash in hand and enters it into the application. The payment service confirms that the amount of available cash matches before allowing the other cashier to continue using the application.

The subordinate cashier application supports a cash collector function. If a cash collector is dispatched to a subordinate cashier, the subordinate cashier collects personal information associated with the cash collector including a name, a mobile number, and an address. The subordinate cashier captures a photograph of the cash collector using the subordinate cashier device 1904, and has the cash collector sign their name on a pressure sensitive display on the subordinate cashier device 1904. The photograph of the cash collector and the signature collected by the subordinate cashier are transmitted to the payment service to authenticate the identity of the cash collector. The head cashier is notified of cash-collection events via an SMS message or via an email.

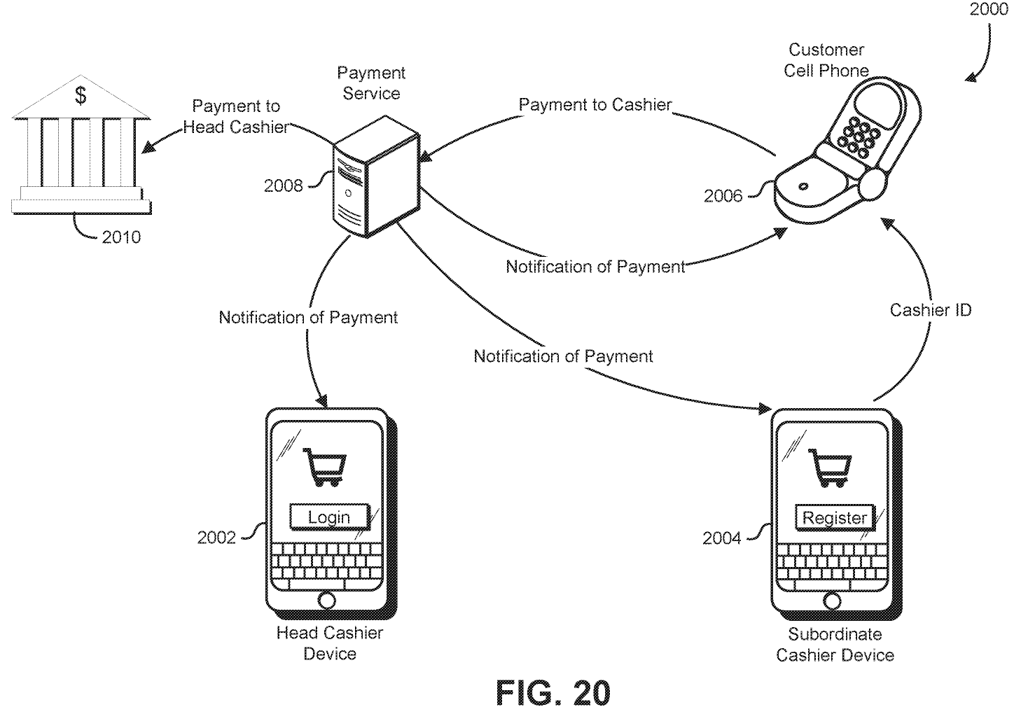

FIG. 20 shows an illustrative example of an environment that processes payments from a customer to a subordinate cashier under the authority of a head cashier. An environment 2000 includes a head cashier device 2002, a subordinate cashier device 2004, and a customer cell phone 2006 that interface with a payment service 2008. The head cashier device 2002 and the subordinate cashier device 2004 run a merchant application where the head cashier device 2002 is operated by a head cashier and the subordinate cashier device 2004 is configured to operate as a subordinate cashier to the head cashier device 2002.

When a customer purchases an item from the subordinate cashier, the customer cell phone 2006 receives, from the subordinate cashier device 2004, information that includes a phone number and a merchant ID of the subordinate cashier. As described above, the information may be encoded in a station ID of a wireless access point or hotspot provided by the subordinate cashier device 2004. Using, the customer cell phone 2006, the customer selects the phone number of the subordinate cashier device 2004, enters a payment amount, and submits a payment request to the payment service 2008.

The payment service 2008 receives the payment request, and looks up the payee specified by the customer. The payment service 2008 identifies the payee as the subordinate cashier, and finds that the subordinate cashier is subordinate to the head cashier. The payment service 2008 looks up the account of the head cashier and replaces the payee of the payment request with the account of the head cashier. The payment service 2008 service identifies a bank account 2010 associated with the head cashier, and transfers funds from an account associated with the customer to the bank account 2010 of the head cashier. The status of the payment request is sent via notifications to the application client 206, the subordinate cashier device 2004, and head cashier device 2002.

In some implementations, a merchant or customer may restrict the set of customers from which the merchant or customer may receive payment. In some examples, the merchant or customer blocks payments from anonymous users. If a payment is received from an anonymous user, the payment service holds the payment in a holding account and notifies the merchant or customer that an anonymous payment has been received. If the merchant or customer sends a confirmation to the payment service, the funds are transferred from the holding account to the merchant or customer. If the merchant or customer sends a rejection to the payment service, the funds are refunded from the holding account to the merchant or customer. If the merchant or customer does not send a confirmation or a rejection within a threshold amount of time, the funds are returned to the anonymous payer.

The set of customers from which payments may be received may be defined using the contact list on the customer device, a black list maintained by the customer, a white list maintained by the customer, a list of trusted organizations maintained by the payment service, or list of government agencies and financial institutions maintained by a third-party. In some examples, the customer may specify that payments may be accepted only after confirmation by the customer.

In some implementations, a digital receipt is provided to confirm goods purchased from a merchant. The digital receipt provides confirmation of a transaction between the customer and a merchant of the payment service. A device under the control of the sender of a digital receipt generates a one-time-use code to act as a digital receipt. The digital receipt may be provided to a recipient in the form of an SMS message or a QR code. If the digital receipt is generated in the form of a QR code, the sender of the receipt displays the QR code on terminal or handheld device, and the receiver of the code captures the QR code with a camera or other imaging device. If the digital receipt is generated in the form of an SMS message, the receipt is sent from the sender to the recipient in an encrypted form. Upon receipt, the recipient uses the information in the QR code or SMS message to acquire access to the one-time-use code. The recipient provides the one-time-use code to the sender. By confirming that the one-time-use code provided by the recipient matches the one-time-use code sent by the sender, the sender is able to confirm that the recipient has received the digital receipt. In some examples, the payment service may confirm that the sender of the digital receipt and the recipient of the digital receipt are within a threshold physical distance before allowing the sender to display the QR code.

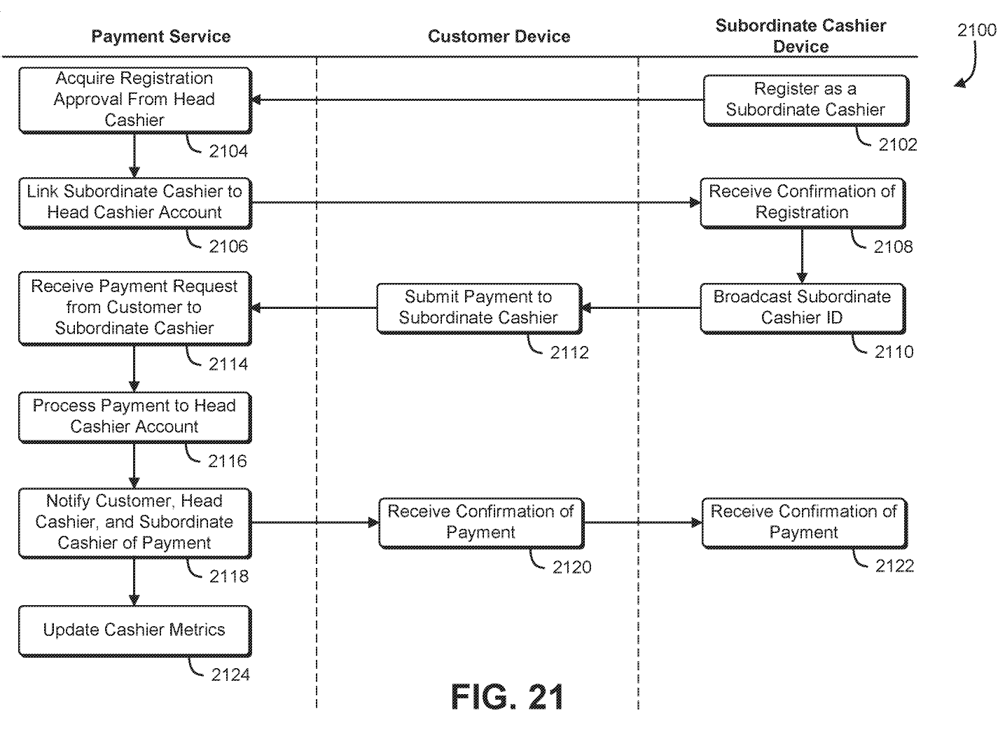

FIG. 21 shows an illustrative example of a process that, when performed by a payment service, a customer, and a subordinate cashier, processes a payment from the customer to the head cashier via the subordinate cashier. A swim diagram 2100 shows a process that begins at block 2102 with a subordinate cashier device being registered for use by a subordinate cashier. As part of the registration process, the subordinate cashier device is linked to a head cashier and a head cashier account.

The subordinate cashier device sends the registration information to the payment service, and the payment service sends a notification to the head cashier via a head cashier device. The notification may be sent via SMS, email, or application notification. At block 2104, the payment service receives an approval to accept the subordinate cashier as a subordinate to the head cashier. The payment service links 2106 the subordinate cashier device to an account associated with the head cashier. In some examples, a link is established by linking the subordinate cashier device to the head cashier's phone number. The head cashier's account may be an account on the payment service or an account managed by an external financial institution.

At block 2108, the subordinate cashier device receives a confirmation of registration from the payment service. The subordinate cashier device configures, on the subordinate cashier device, a wireless hotspot, such as a Wi-Fi hotspot or Bluetooth hotspot, with a station ID that communicates payment information for the subordinate cashier device. In some examples, the station ID is an encoded version of the subordinate cashier's phone number and a description of the business operated by the head cashier. The subordinate cashier device broadcasts 2110 the payment information to nearby customer devices via the wireless hotspot.

When the customer makes a purchase from the subordinate cashier, the customer device receives the payee information via the wireless hotspot, and uses the received payment information to enter payment details. The completed payment information is submitted 2112 to the payment service.

The payment service receives 2114 the payment request from the customer device. The payment request includes a payment amount and identifies the subordinate cashier as the payee. At block 2116, the payment examines the payment request and determines that payments to the subordinate cashier are redirected to the head cashier. The payment service processes payment from the customer account to the head cashier account. At block 2118, the payment service notifies the customer, the head cashier, and the subordinate cashier when a payment has been made. At block 2120, the customer device receives notification that the payment is complete. At block 2122, the subordinate cashier device receives confirmation that the payment is complete.

At block 2124, the payment service updates metrics associated with the subordinate cashier. In various examples, the payment service records an amount of business facilitated by the subordinate cashier. In another example, the payment service records locations where the subordinate cashier has conducted business. In yet another example, the payment service records the hours worked by the subordinate cashier.

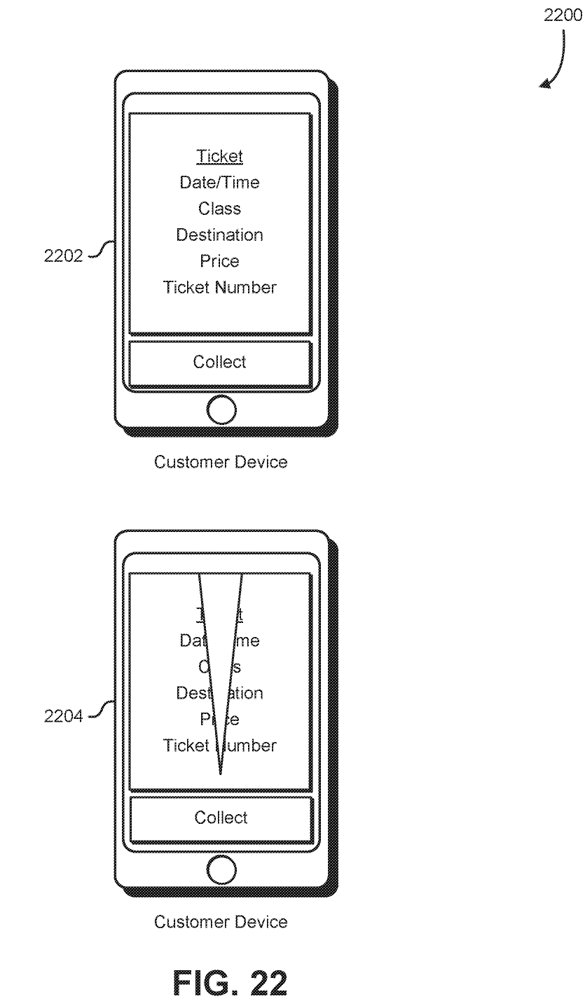

FIG. 22 shows an illustrative example of a customer device that provides electronic ticketing functions. A diagram 2200 shows a ticket distribution and validation system that may be part of a payment service. A first customer device 2202 shows a valid ticket issued by the ticket distribution and validation system. The ticket includes a date and time for travel, a class, a destination, a price paid for the ticket, and a ticket number. In some examples, the ticket includes a two dimensional QR code that encodes the above information. The first customer device provides a collect button that, when selected, invalidates the ticket. A second customer device 2204 shows the ticket after the ticket has been invalidated. A visual tear is animated through the ticket to indicate that the ticket has been collected by a ticketing agent.

A complementary application may be provided to the ticketing agent. In one example, an application is provided for train station personnel. The application issues rail transportation tickets to payment service customers, and notifies the customers of arrival and departure times via an SMS notification. In another example, an application is provided for bus drivers. The application used by the bus driver receives ticketing details for persons riding the bus. Using the application, the bus driver is able to determine the number of people on the bus that have tickets, and the number of people that will be boarding and on boarding at each bus stop.

Other forms of ticketing may be supported by the payment service. A generic booking engine is built for the merchant to customize their online booking requirements. The merchant can build their own infrastructure and seating arrangements. One booking engine serves the merchant of all sectors, such as movie theatres, bus booking etc. A merchant may have access to a fully interactive admin panel for creating the seat layouts and pricing. Customers can see the different merchants from the mobile application and may book the tickets easily.

This works similar to the traditional booking system with the exception that one system can be configured to serve multiple sectors. For example, the system can be configured for banquet or movie ticket booking.

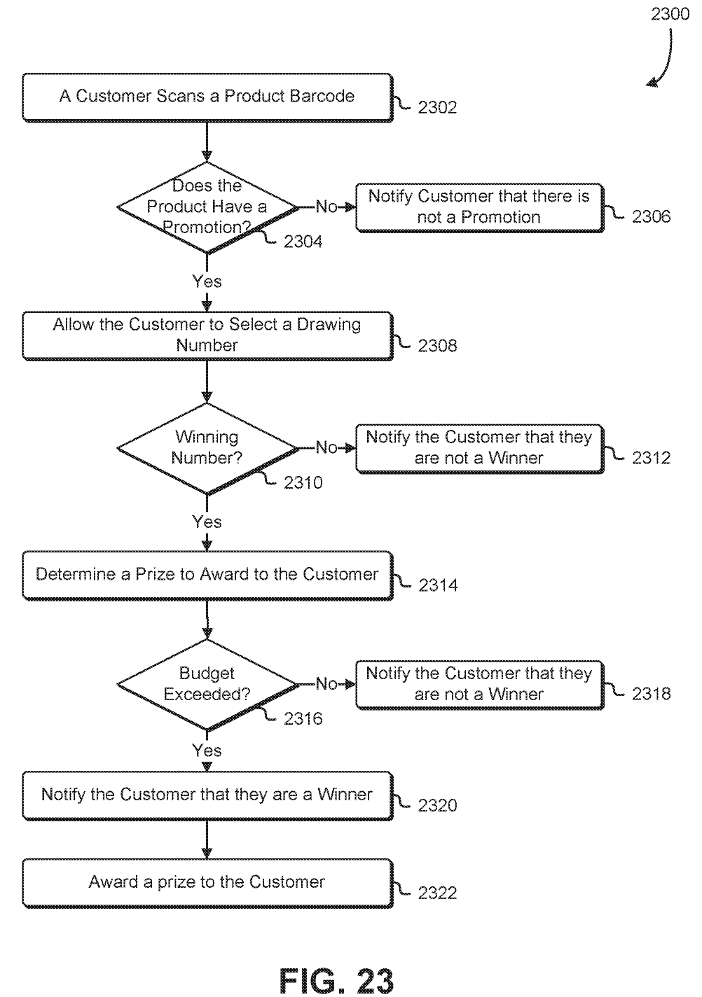

FIG. 23 shows an illustrative example of a process that, when performed by a payment service, performs a lucky draw promotion for a product scanned by a customer device. A process diagram 2300 shows a process that begins at block 2302 where a payment service receives a product barcode scanned by a customer device. At decision block 2304, the payment service examines a database of products maintained by the merchant. The database specifies which products are eligible for a lottery promotion. If the scanned product barcode is not associated with a promoted product, execution proceeds to block 2306 and the payment service notifies the customer that there is not an active promotion for the product. If the payment service determines that the product does have an active promotion, execution proceeds to block 2308 and the payment service allows the customer to select a lottery number. The customer enters the lottery number using an application running on a customer's mobile device, and the lottery number is returned to the payment service. At block 2310, the payment service determines whether the entered lottery number is a winning number by comparing the entered lottery number to a winning number stored in the database on the payment service. If the entered lottery number is not a winning number, execution proceeds to block 2312 and the customer is notified that they are not a winner.

If the entered lottery number is a winning number, execution proceeds to block 2314 and the payment service determines a prize to be awarded to the customer. In some examples, the prize may be a discount percentage. In another example, the prize may be a free product. In yet another example, the prize may be an additional product. In yet another example, the prize may be an amount of cash. The merchant may set a budget amount for prizes. At block 2216, the payment system determines if the determined award would exceed the specified budget. If the determined award would exceed the specified budget, execution proceeds to block 2318 and the payment service notifies the customer that they are not a winner. Otherwise, execution of the process proceeds to block 2320 and the customer is notified that they are winner. The determined prize is awarded at block 2322.

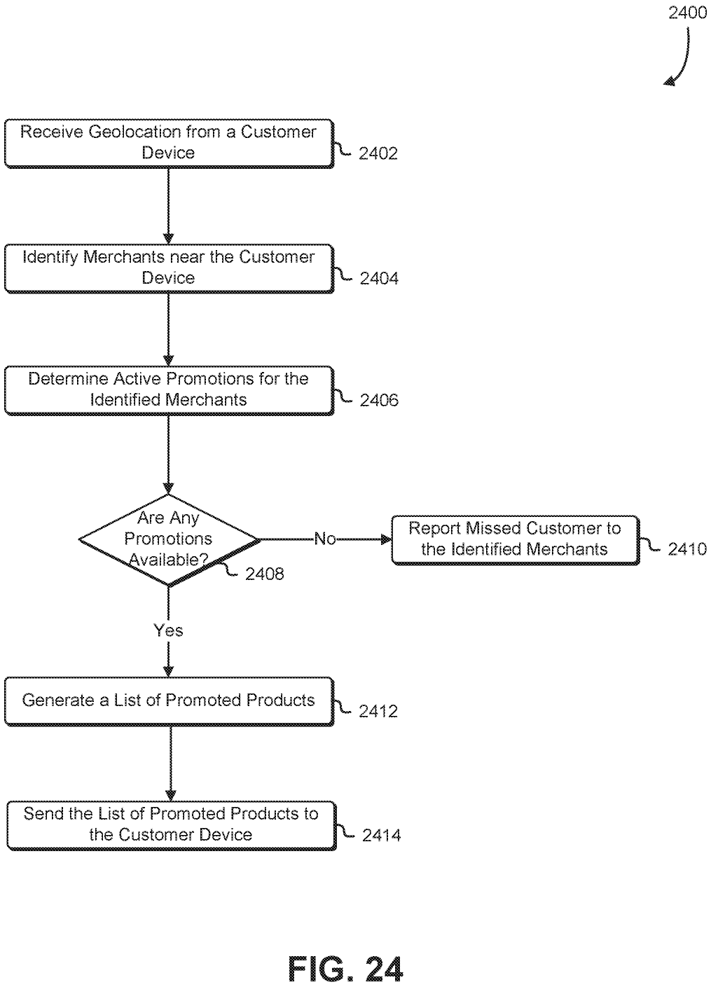

FIG. 24 shows an illustrative example of a process that, when performed by a payment service, presents product promotions on a customer device based at least in part on a geo location of the customer device. A process diagram 2400 begins at block 2402 for a payment service and receives geo location information from a customer device. The geo location information is used by the payment service to identify 2404 active merchants which are registered with the payment service, and which are within a threshold distance of the customer device. The threshold distance may be determined based at least in part on the amount of time it would take the customer to travel to the merchant. For example, the threshold distance may be the distance a potential customer is able to travel in 5 minutes, at walking speed. At block 2406, the payment service queries the information stored within the payment service to identify a set of promotions associated with the active merchants. If the payment service determines 2408 that there are not any active promotions associated with the active merchants, execution proceeds to block 2410. At block 2410, the payment service reports, to the identified active merchants, that a promotional opportunity has been missed. If the payment service determines that there are active promotions associated with the active merchants, the payment service generates 2412 a list of the promotions, and sends 2414 the list of promotions to the customer device.

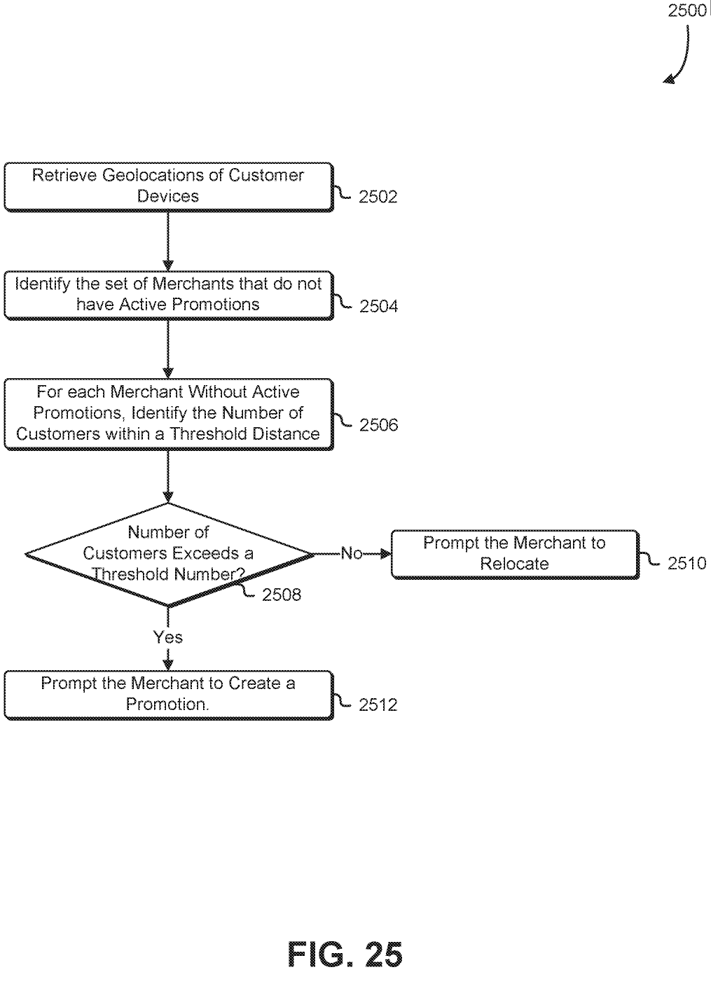

FIG. 25 shows an illustrative example of a process that, when performed by a payment service, identifies merchants that miss promotional opportunities and presents promotional alternatives to the merchants. A process diagram 2500 begins at block 2502 with the payment service retrieving, from storage on the payment service, a number of Geo locations associated with customer devices. A block 2504, the payment service queries a database containing the list of merchants that are registered with the payment service, and identifies those merchants that do not have active product promotions.

For each merchant that does not have an active promotion, the payment service examines the geo location's associated with the customer devices, and determines a number of customers that are within a threshold distance of the merchant. The threshold distance is established by determining the distance a customer may travel to do business with the merchant. At decision block 2508, the payment service compares the number of customers that are within the threshold distance to a second threshold number. The second threshold number is the number of customers that need to see a promotion so that the cost of the promotion is recovered. If the number of customers that are within threshold distance is not greater than the second threshold number, execution proceeds to block 2510 and the payment service suggests, to the merchant, that the merchant relocate or shutdown. If the number of customers that are within threshold distance is greater than or equal to the second threshold number, then execution proceeds to block 2512 in the payment service to provide suggestions on how to capitalize on the marketing opportunity. The suggestions to the merchant may include generating a new promotion, announcing a product lottery, or sending in additional cashiers. In this way, the payment service is able to make suggestions to merchants that can increase sales and reduce operational costs.

Embodiments of the disclosure can be described in view of the following clauses:

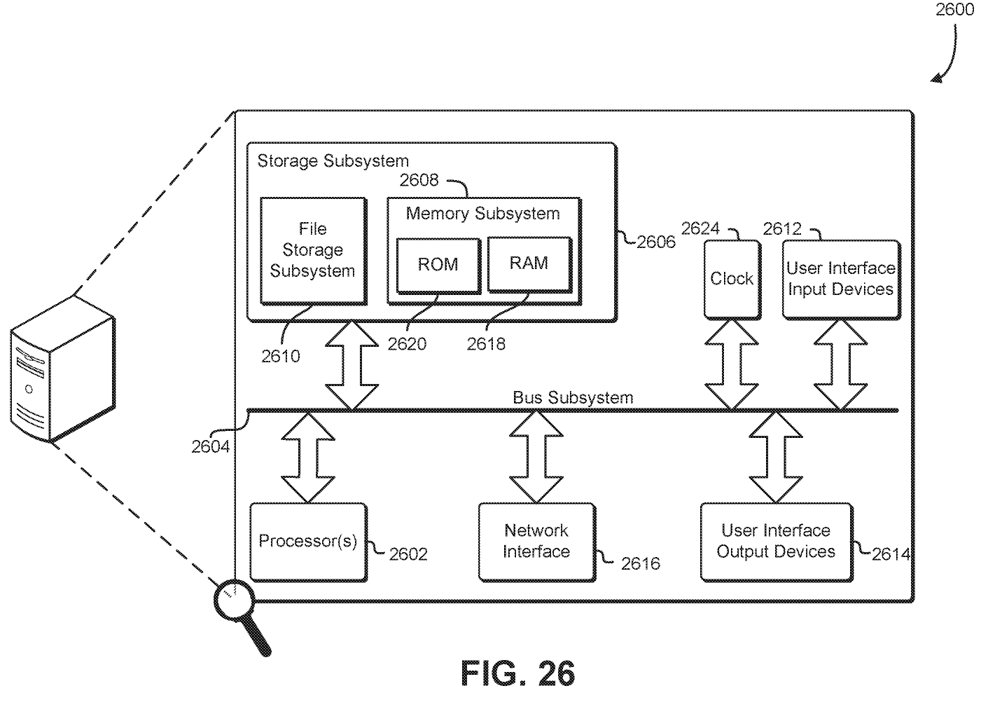

FIG. 26 illustrates an environment in which various embodiments can be implemented. FIG. 26 is an illustrative, simplified block diagram of an example computing device 2600 that may be used to practice at least one embodiment of the present disclosure. In various embodiments, the computing device 2600 may be used to implement any of the systems illustrated herein and described above. For example, the computing device 2600 may be configured for use as a data server, a web server, a portable computing device, a personal computer, or any electronic computing device. As shown in FIG. 26, the computing device 2600 may include one or more processors 2602 that may be configured to communicate with, and are operatively coupled to, a number of peripheral subsystems via a bus subsystem 2604. The processors 2602 may be utilized for the traversal of decision trees in random forest of supervised models in embodiments of the present disclosure (e.g., cause the evaluation of inverse document frequencies of various search terms, etc.). These peripheral subsystems may include a storage subsystem 2606, comprising a memory subsystem 2608 and a file storage subsystem 2610, one or more user interface input devices 2612, one or more user interface output devices 2614, and a network interface subsystem 2616. Such storage subsystem 2606 may be used for temporary or long-term storage of information such as details associated with transactions described in the present disclosure, databases of historical records described in the present disclosure, and storage of decision rules of the supervised models in the present disclosure).

The bus subsystem 2604 may provide a mechanism for enabling the various components and subsystems of computing device 2600 to communicate with each other as intended. Although the bus subsystem 2604 is shown schematically as a single bus, alternative embodiments of the bus subsystem utilize multiple busses. The network interface subsystem 2616 may provide an interface to other computing devices and networks. The network interface subsystem 2616 may serve as an interface for receiving data from, and transmitting data to, other systems from the computing device 2600. For example, the network interface subsystem 2616 may enable a data technician to connect the device to a wireless network such that the data technician may be able to transmit and receive data while in a remote location, such as a user data center. The bus subsystem 2604 may be utilized for communicating data, such as details, search terms, and so on to the supervised model of the present disclosure, and may be utilized for communicating the output of the supervised model to the one or more processors 2602 and to merchants and/or creditors via the network interface subsystem 2616.

The user interface input devices 2612 may include one or more user input devices, such as a keyboard, pointing devices such as an integrated mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to the computing device 2600. The one or more user interface output devices 2614 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2600. The one or more output devices 2614 may be used, for example, to present user interfaces to facilitate user interaction with applications performing processes described herein and variations therein, where such interaction may be appropriate.

The storage subsystem 2606 may provide a computer-readable storage medium for storing the basic programming and data constructs that may provide the functionality of at least one embodiment of the present disclosure. The applications (programs, code modules, instructions) that, as a result of being executed by one or more processors, may provide the functionality of one or more embodiments of the present disclosure, and may be stored in the storage subsystem 2606. These application modules or instructions may be executed by the one or more processors 2602. The storage subsystem 2606 may additionally provide a repository for storing data used in accordance with the present disclosure. The storage subsystem 2606 may comprise a memory subsystem 2608 and a file/disk storage subsystem 2610.

The memory subsystem 2608 may include a number of memories, including a main random access memory (RAM) 2618 for storage of instructions and data during program execution and a read only memory (ROM) 2620 in which fixed instructions may be stored. The file storage subsystem 2610 may provide a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

The computing device 2600 may include at least one local clock 2624. The local clock 2624 may be a counter that represents the number of ticks that have transpired from a particular starting date and may be located integrally within the computing device 2600. The local clock 2624 may be used to synchronize data transfers in the processors for the computing device 2600 and all of the subsystems included therein at specific clock pulses and may be used to coordinate synchronous operations between the computing device 2600 and other systems in a data center. In one embodiment, the local clock 2624 is an atomic clock. In another embodiment, the local clock is a programmable interval timer.

The computing device 2600 may be of various types, including a portable computer device, tablet computer, a workstation, or any other device described below. Additionally, the computing device 2600 may include another device that may be connected to the computing device 2600 through one or more ports (e.g., USB, a headphone jack, Lightning connector, etc.). The device that may be connected to the computing device 2600 may include a plurality of ports configured to accept fiber-optic connectors. Accordingly, this device may be configured to convert optical signals to electrical signals that may be transmitted through the port connecting the device to the computing device 2600 for processing. Due to the ever-changing nature of computers and networks, the description of the computing device 2600 depicted in FIG. 26 is intended only as a specific example for purposes of illustrating the preferred embodiment of the device. Many other configurations having more or fewer components from the system depicted in FIG. 26 are possible.

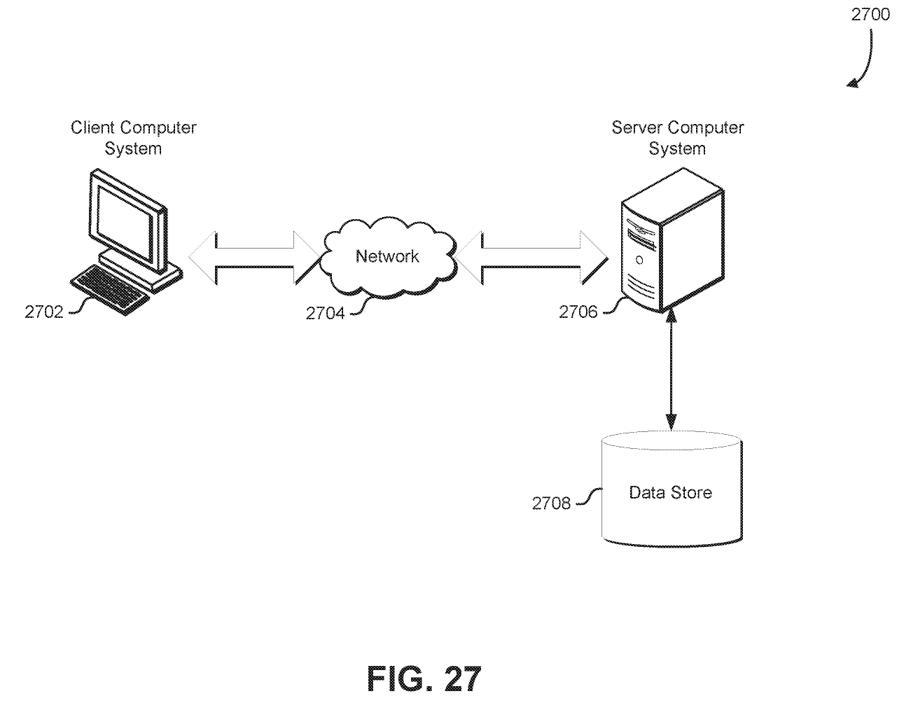

FIG. 27 illustrates aspects of an example environment 2700 for implementing aspects in accordance with various embodiments. A client/server environment is shown for the purposes of explanation, but other environments may be used in other implementations. The environment includes a client computer system 2702. The client computer system can be a desktop computer, laptop computer, computing appliance, or mobile device that is able to send or receive information over a computer network 2704. Other examples of client computer systems include cell phones, tablet computers, wearable devices, personal digital assistants (“PDAs”), embedded control systems, and smart appliances. The computer network 2704 can be a wired or wireless network. Wired networks can include wired networks such as Ethernet (1ObaseT, 1OObaseT, or Gigabit), AppleTalk, Token Ring, Fiber Channel, USB, RS-232, or Power line networks, or wireless networks such as 802.11 Wi-Fi, Bluetooth, or infrared-communication-based networks. A variety of communication protocols may be used over the computer network 2704. The communication protocols may include TCP/IP, IPX, or DLC. A variety of intermediate protocols may operate on top of these protocols such as HTTP, HTTP secure (“HTTPS”), simple network management protocol (“S MP”), and simple mail transfer protocol (“SMTP”). The computer network 2704 may include a combination of sub networks including the Internet, internal home networks, or business intranets.

The environment includes a server computer system 2706. The server computer system 2706 receives requests from various computer systems connected to the computer network 2704 including the client computer system 2702. The server computer system 2706 can be a server computer system, a number of server computer systems arranged in a server cluster, or virtual computer system capable of receiving requests and sending responses over the computer network 2704. In some environments, a personal computer system, handheld device, or cell phone can perform the functions of the server computer system 2706. If more than one addressable device is used to process requests, a load balancer or other coordinating entity such as a firewall may be placed between the client computer system 2702 and a server computer system 2706. The load balancer may receive requests on behalf of a collection of server devices, and route requests across the collection of server devices.

The server computer system 2706 may implement a plurality of services by exporting more than one service interface. For example, a number of services may be implemented on the server computer system 2706 as a corresponding number of processes. Each process may be bound to different network address and/or network port. A particular network client can access a particular service by submitting a request to the corresponding network address and port.

The server computer system 2706 is connected to a data store 2708. The term data store may refer to a device capable of storing and retrieving computer readable information such as disk drives, semiconductor RAM, ROM, flash memory, optical disk, CD-ROM, EEPROM. In some implementations, right-once/read-many memory such as EEPROM memory may be used to generate a data store. In some implementations, a database may be used to store information. In some examples, a database may be created through the use of a commercial application such as SQL Server, Oracle, Access, or other relational database engine. Tables and keys are defined that allow for rapid and efficient access to information using particular key values. Tables may be linked for quick and efficient access to data. Relational database engines allow operations to be performed on stored data using a standard query language (“SQL”). SQL commands or scripts may be submitted that create, alter, delete, or synthesize information stored within the database. Those skilled in the art will appreciate that, in some systems, some database functions may be integrated into an application. Hash tables, ordered lists, stacks and queues may be implemented and arranged to perform similar functionality in many applications. The term “data store” refers to any device or combination of devices capable of storing, accessing and retrieving data, which may include any combination and number of data servers, databases, data storage devices and data storage media, in any standard, distributed, virtual or clustered environment. As used herein, the term “database” refers to both commercial database engines and custom implementations of database functionality using ordered and indexed data structures, hash tables, arrays, linked lists, key-value pair structures, and the like.

A server computer system 2706 may provide access and authentication controls that limit access to the information maintained in the data store 2708. An authentication system controls access to the server computer system by verifying the identity of the person or entity submitting a request to the server computer system 2706. Authentication is achieved by validating authentication information such as a username and password, a digital signature, or a biometric value. In some implementations, authentication occurs through the submission of a username and password known only by an authorized user. In another implementation, authentication affairs to the submission of a digital signature using a cryptographic key known to be under the control of the client computer system 2702. The cryptographic key may be a private cryptographic key associated with a digital certificate. Requests submitted to the server computer system 2706 may be subject to authorization controls. Authorization controls may be based at least in part on the identity of the requester or the requesting device. In some implementations, authorization controls may subject service requests to a time-based or data-rate throttling limitation.

Content stored on the data store 2708 and served by the server computer system 2706 may include documents, text, graphics, music or audio, video content, executable content, executable scripts, or binary data for use with a computer application. For example, content served by Web server may be in Hyper Text Markup Language (“HTML”), Extensible Markup Language (“XML”), JavaScript, Cascading Style Sheets (“CSS”), JavaScript Object Notation (JSON), and/or another appropriate format. Content may be served from the server computer system 2706 to the client computer system 2702 in plaintext or encrypted form.

Data encryption may be accomplished using various forms of symmetric and/or asymmetric cryptographic primitives. Symmetric key algorithms may include various schemes for performing cryptographic operations on data including block ciphers, stream ciphers and digital signature schemes. Example symmetric key algorithms include the advanced encryption standard (AES), the data encryption standard (DES), triple DES (3DES), Serpent, Twofish, blowfish, CASTS, RC4 and the international data encryption algorithm (IDEA). Symmetric key algorithms may also include those used to generate output of one way functions and include algorithms that utilize hash-based message authentication codes (HMACs), message authentication codes (MACs) in general, PBKDF2 and Bcrypt. Asymmetric key algorithms may also include various schemes for performing cryptographic operations on data. Example algorithms include those that utilize the Diffie-Hellman key exchange protocol, the digital signature standard (DSS), the digital signature algorithm, the ElGamal algorithm, various elliptic curve algorithms, password-authenticated key agreement techniques, the pallier cryptosystem, the RSA encryption algorithm (PKCS#1), the Cramer-Shoup cryptosystem, the YAK authenticated key agreement protocol, the NTRUEncrypt cryptosystem, the McEliece cryptosystem, and others. Elliptic curve algorithms include the elliptic curve Diffie-Hellman (ECDH) key agreement scheme, the Elliptic Curve Integrated Encryption Scheme (ECIES), the Elliptic Curve Digital Signature Algorithm (ECDSA), the ECMQV key agreement scheme and the ECQV implicit certificate scheme. Other algorithms and combinations of algorithms are also considered as being within the scope of the present disclosure and the above is not intended to be an exhaustive list.

Note that the term “digital signature” includes any information usable to cryptographically verify authenticity of a message including information generated using an RSA-based digital scheme (such as RSA-PSS), the digital signature algorithm (DSA) and the elliptic curve digital signature algorithm, the ElGamal signature scheme, the Schnorr signature scheme, the Pointcheval-Stern signature algorithm, the Rabin signature algorithm, pairing-based digital signature schemes (such as the Boneh-Lynn-Schacham signature scheme), undeniable digital signature schemes, and others. Further, message authentication codes (such as hash-based message authentication codes (HMACs), keyed cryptographic hash functions, and other types of information may also be used as digital signatures.

It should be noted that the phrase “one-way function” includes functions that are not necessarily one-way in the strict mathematical sense, but that exhibit properties (such as collision resistance, pre image resistance and second pre image resistance) that render the function useful in contexts in which the various techniques of the present disclosure are applied. In this manner, an entity with output of the function but without access to the corresponding input, is unable to determine the input without, for instance, extraordinary expenditure of computational resources necessary for a cryptographic (e.g., brute force) attack. One-way functions (also referred to as “effectively one-way functions”) include, but are not limited to, cryptographic hash functions such as message authentication codes, (e.g., hash based message authentication code (HMAC)), key derivation functions, such as PBKDF2 and bcrypt (with the password being based at least in part on the plaintext and the cryptographic key, e.g.) and other secure randomization functions which may, but do not necessarily, have a domain (set of possible inputs) that is larger than their range (possible outputs). Other suitable functions (referred to as “f”) for various embodiments include, but are not limited to, functions that take at least a plaintext and cryptographic key as input and that have a property of pre image resistance (given a value y, the probability of randomly generating an input x such that f(x)=y is below a specified threshold), second pre image resistance (given an input x1, the probably of randomly generating another input x2, different from x1, such that f(x1)=f(x2) is below a specified threshold) and/or collision resistance (the probability of two different inputs resulting in the same output is less than a specified threshold). The exact threshold for each probability may be context-dependent, with lower probabilities corresponding to higher security contexts. Hash functions usable as one-way functions in accordance with the techniques of the present disclosure include, but are not limited to, functions described in the National Institute of Standards and Technology (NIST) Special Publication 800-107, Revision 1 “Recommendation for Applications Using Approved Hash Algorithms,” which is incorporated herein by reference.

The short-range wireless communication channel may be established using various technologies, such as induction wireless, infrared wireless (such as technologies operating according to specifications and protocols provided by the Infrared Data Association or IrDA) or ultra-wideband formats. In some embodiments, the first and second devices may utilize short-range, low-power and high-frequency radio transmissions, such as Bluetooth®. In still other embodiments, the first and second devices may support acoustic-based data transfer. For example, the second device may include software components and a speaker that enable the second device to broadcast data to the first device as sound waves, while the first device may include software components and microphone that enable the second device to receive the data embedded in the sound waves. Thus, one or more of radio signal-based data transfer (e.g., near field communication (NFC) or Bluetooth®), light-based data transfer (e.g., infrared data transfer), an acoustic-based data transfer (e.g., sound wave-embedded data), or magnetic field-based transfer (e.g., reading data from a magnetic stripe) may be used for inter-device communication. The protocols and components for enabling computing devices to perform the systems and methods of the present disclosure using such means for inter-device communication are well known to those skilled in the art of computer communications and thus, need not be described in more detail herein. Generally, embodiments described herein are not limited to those explicitly illustrated herein.

Note also that the examples used herein may be performed in compliance with one or more of: Request for Comments (RFC) 4250, RFC 4251, RFC 4252, RFC 4253, RFC 4254, RFC 4255, RFC 4256, RFC 4335, RFC 4344, RFC 4345, RFC 4419, RFC 4432, RFC 4462, RFC 4716, RFC 4819, RFC 5647, RFC 5656, RFC 6187, RFC 6239, RFC 6594, and RFC 6668, which are incorporated by reference.

Generally, embodiments of the present disclosure may use various protocols, such as a SSL or TLS protocol and extensions thereto, such as defined in Request for Comments (RFC) 2246, RFC 2595, RFC 2712, RFC 2817, RFC 2818, RFC 3207, RFC 3268, RFC 3546, RFC 3749, RFC 3943, RFC 4132, RFC 4162, RFC 4217, RFC 4279, RFC 4347, RFC 4366, RFC 4492, RFC 4680, RFC 4681, RFC 4785, RFC 5054, RFC 5077, RFC 5081, RFC 5238, RFC 5246, RFC 5288, RFC 5289, RFC 5746, RFC 5764, RFC 5878, RFC 5932, RFC 6083, RFC 6066, RFC 6091, RFC 6176, RFC 6209, RFC 6347, RFC 6367, RFC 6460, RFC 6655, RFC 7027, and RFC 7366 which are incorporated herein by reference, to establish encrypted communications sessions. Other protocols implemented below the application layer of the Open Systems Interconnect (OSI) model may also be used and/or adapted to utilize techniques described herein. It should be noted that the techniques described herein are adaptable to other protocols such as the Real Time Messaging Protocol (RTMP), the Point-to-Point Tunneling Protocol (PPTP), the Layer 2 Tunneling Protocol, various virtual private network (VPN) protocols, Internet Protocol Security (e.g., as defined in RFC 1825 through 1829, RFC 2401, RFC 2412, RFC 4301, RFC 4309, and RFC 4303) and other protocols, such as protocols for secure communication that include a handshake.

Note that a system is said to be configured to trust a public cryptographic key if logic with which the system is configured to operate is dependent on whether an attempt to verify a digital signature with the public cryptographic key is successful. Similarly, a system is said to be configured to trust a symmetric cryptographic key if logic with which the system is configured to operate is dependent on whether an attempt to verify a digital signature with the symmetric cryptographic key is successful.

The location of the system can be determined using a variety of geo location technologies such as global positioning systems (“GPS”), Wi-Fi based positioning systems (“WPS”), LORAN, GLONASS (Globalnaya navigatsionnaya sputnikovaya sistema), Galileo global navigation satellite system, BeiDou Navigation Satellite System, Bluetooth-based positioning systems such as Zonith, or other geolocation hardware built into the system. In some implementations, terrestrial aviation-navigation signals such as Automatic Direction Finding (“ADF”), VHF Omnirange (“VOR”), are used to determine the geo location of the system.

In various embodiments, data objects such as digital signatures may be cryptographically verifiable. In one example, cryptographically verifiable data objects are created to be cryptographically verifiable by the system to which the data object is to be provided or another system that operates in conjunction with the system to which the data object is to be provided. For example, the data object may be encrypted so as to be decryptable by the system that will cryptographically verify the data object, where the ability to decrypt the data object serves as cryptographic verification of the data object. As another example, the data object may be digitally signed (thereby producing a digital signature of the data object) such that the digital signature is verifiable by the system that will cryptographically verify the data object. In other examples, both encryption and digital signatures are used for cryptographic verifiability and/or security. The key used to encrypt and/or digitally sign the data object may vary in accordance with various embodiments and the same key is not necessarily used for both encryption and digital signing, where applicable. In some embodiments, a key used to encrypt the data object is a public key of a public/private key pair where the private key of the key pair is maintained securely by the system to which the data object is to be provided, thereby enabling the system to decrypt the data object using the private key of the key pair. Using the public key to encrypt the data object may include generating a symmetric key, using the symmetric key to encrypt the data object, and encrypting the symmetric key using the public key, where the encrypted symmetric key is provided to a system with the encrypted data object to enable the system to use the corresponding private key to decrypt the symmetric key and use the decrypted symmetric key to decrypt the data object. Further, in some embodiments, the data object is digitally signed using a private key of a public/private key pair corresponding to the computer system that encrypts and/or digitally signs the data object (e.g., a user device). For example, an application may be provisioned with the private key and the data object may include a certificate for the private key for use by a system for verification of the digital signature of the data object. Other variations, including variations where a symmetric key shared between the user computer and the system that cryptographically verifies the data object can be used to encrypt and/or digitally sign the data object.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. In some embodiments, the code is stored on set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media may comprise multiple non-transitory computer-readable storage media and one or more of individual non-transitory storage media of the multiple non-transitory computer-readable storage media may lack all of the code while the multiple non-transitory computer-readable storage media collectively store all of the code. Further, in some examples, the executable instructions are executed such that different instructions are executed by different processors. As an illustrative example, a non-transitory computer-readable storage medium may store instructions. A main CPU may execute some of the instructions and a graphics processor unit may execute other of the instructions. Generally, different components of a computer system may have separate processors and different processors may execute different subsets of the instructions.

Accordingly, in some examples, computer systems are configured to implement one or more services that singly or collectively perform operations of processes described herein. Such computer systems may, for instance, be configured with applicable hardware and/or software that enable the performance of the operations. Further, computer systems that implement various embodiments of the present disclosure may, in some examples, be single devices and, in other examples, be distributed computer systems comprising multiple devices that operate differently such that the distributed computer system performs the operations described herein and such that a single device may not perform all operations.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
under the control of one or more computer systems configured with executable instructions,
receiving, in an SMS message sent from a client device, a one-time-use passcode and information that identifies a phone number of the client device;
storing the phone number of the client device in association with the one-time-use passcode;
receiving, from the client device, a registration request that includes the one-time-use passcode;
looking up the phone number of the client device using the one-time-use passcode;
registering the client device with a service by creating an account, and linking the account to the phone number;
receiving a transaction request from the client device, the transaction request identifying the phone number of the client device and specifying a payee phone number; and
fulfilling the transaction request by at least transferring funds from the account to a payee account associated with the payee phone number.

2. The computer-implemented method of claim 1, further comprising:
as part of registering the client device, receiving, from the client device, an encrypted SIM ID, MSID, and IMEI for the client device;
storing the encrypted SIM ID, MSID, and IMEI; and
confirming the SIM ID, MSID, and IMEI of the client device as a condition of fulfilling the transaction request.

3. The computer-implemented method of claim 1, wherein:
the transaction request is received via an SMS message; and
the account is identified based at least in part on a source of the transaction request.

4. The computer-implemented method of claim 1, further comprising:
receiving, from the client device, information usable to verify the identity of a user of the client device, the information including a signature and a video clip of the user; and
verifying the identity of the user using the signature and the video clip as a condition of fulfilling the transaction request.

5. A system, comprising at least one computing device configured to implement one or more services, wherein the one or more services are configured to:
register a client device with the one or more services by at least in part:
receiving, in an SMS message sent from the client device, a one-time-use passcode;
determining a phone number associated with the client device based at least in part on an origin of the SMS message;
storing, in a memory accessible to the one or more services, the one-time-use passcode in association with the phone number associated with the client device;
receiving, from the client device, a registration request that includes the one-time-use passcode;
determining the phone number of the client device at least in part by retrieving, from the memory, the phone number associated with the one-time-use passcode;
creating an account for client device on the one or more services; and
associating the account with the phone number of the client device; and
fulfill a transaction request submitted by the client device by at least in part:
authenticating the transaction request; and
transferring funds from the account to a payee account identified by the transaction request.

6. The system of claim 5, wherein the one or more services are further configured to:
register a client device with the one or more services by at least in part receiving a biometric value that identifies a user of the client device; and
fulfill a transaction request submitted by the client device by at least in part confirming the identity of the user based at least in part on the biometric value.

7. The system of claim 6, wherein:
the biometric value is a video clip of the user; and
confirming the identity of the user is accomplished at least in part by:
splitting the video clip into a plurality of still images;
determining that a threshold percentage of the still images are different from each other; and
determining that a person in the video clip is the user.

8. The system of claim 6, wherein:
the biometric value is a signature of the user; and
confirming the identity of the user is accomplished at least in part by comparing the signature of the user to a saved image of the user's signature.

9. The system of claim 5, wherein the one or more services are further configured to:
determine that the payee is registered as a subordinate cashier under a head cashier;
identify a head-cashier account associated with the head cashier; and
cause funds that are directed to the payee account identified by the transaction request to be redirected to the head-cashier account associated with the head cashier.

10. The system of claim 5, wherein the one or more services are further configured to:
receive geolocation information from the client device;
determine that the client device is within a threshold distance of a merchant device;
identify a merchant that is registered with the one or more services, and associated with the merchant device;
determine that the merchant does not have any active promotions; and
send a notification to the merchant via the merchant device that informs the merchant of a missed promotional opportunity.

11. The system of claim 5, wherein:
the payee account is identified with an unregistered phone number that is not registered with the one or more services; and
the one or more services are further configured to:
create a provisional account associated with the unregistered phone number; and
send a message to the unregistered phone number, the message indicating that the funds are available to be claimed.

12. The system of claim 5, wherein the one or more services are further configured to:
detect that a user is attempting to access the one or more services using a replacement device;
send an SMS message to the phone number of the client device containing a one-time-use code;
receive biometric information that identifies the user of the replacement device, the information including the one-time-use code; and
update registration information to reflect the replacement of the client device with the replacement device.

13. A non-transitory computer-readable storage medium having stored thereon executable instructions that, as a result of being executed by one or more processors of a computer system, cause the computer system to at least:
register with a payment service by at least in part:
generating a one-time-use passcode;
sending the one-time-use passcode to the payment service via an SMS message;
acquiring authentication information from a user; and
sending a registration request to the payment service, the registration request including the authentication information and the one-time-use passcode; and
cause a transaction to be fulfilled at least in part by:
sending a transaction request to the payment service, the transaction request including a destination phone number and an amount of payment.

14. The non-transitory computer-readable storage medium of claim 13, wherein the instructions further comprise instructions that, as a result of being executed by the one or more processors, cause the computer system to:
encode a phone number that is associated with the computer system to produce an encoded payee phone number; and
broadcast, via a short-range wireless communication channel, the encoded payee phone number.

15. The non-transitory computer-readable storage medium of claim 14, wherein the encoded payee phone number is encoded at least in part by, for each digit in the phone number:
adding the value of the digit to a position index of the digit to produce a digit value; and
replacing each digit value with a letter, the letter based at least in part on the digit value.

16. The non-transitory computer-readable storage medium of claim 13, wherein the instructions further comprise instructions that, as a result of being executed by the one or more processors, cause the computer system to confirm a phone number entered by a user by at least:
sending an SMS message to the phone number, the SMS message including a one-time-use code;
receiving the SMS message at the computer system; and
determining that the phone number is associated with the computer system by at least confirming that the received SMS message includes the one-time-use code.

17. The non-transitory computer-readable storage medium of claim 13, wherein the instructions further comprise instructions that, as a result of being executed by the one or more processors, cause the computer system to:
receive, from the payment service, information describing a valid ticket;
display an image that represents the ticket on a display connected to the computer system;
receive a command to collect the ticket; and
modify the image to include a visual tear through the image.

18. The non-transitory computer-readable storage medium of claim 13, wherein the transaction request is encrypted using Triple DES encryption.

19. The non-transitory computer-readable storage medium of claim 13, wherein the instructions further comprise instructions that, as a result of being executed by the one or more processors, cause the computer system to:
send a geolocation of the computer system to the payment service; and
receive, from the payment service, a set of promotions by nearby merchants.

20. The non-transitory computer-readable storage medium of claim 13, wherein the transaction request is sent to the payment service via an SMS message, an HTTP secure connection, or an interactive voice response system.
